(19) United States
(12) Patent Application Publication
(10) Pub. No.: US 2015/0339285 A1
(43) Pub. Date: Nov. 26, 2015

(54) Methods and Systems for Batch Generation and Delivery of Customized Documents

(71) Applicants: Aman Safaei, Alpharetta, GA (US); Manijeh Behzadi, Alpharetta, GA (US)

(72) Inventors: Aman Safaei, Alpharetta, GA (US); Manijeh Behzadi, Alpharetta, GA (US)

(21) Appl. No.: 14/692,766

(22) Filed: Apr. 22, 2015

Related U.S. Application Data
(60) Provisional application No. 61/982,632, filed on Apr. 22, 2014.

(51) Int. Cl. G06F 17/24; G06F 17/30; H04L 12/58

(52) U.S. Cl. CPC G06F 17/248; H04L 51/08; G06F 17/30106

(57) ABSTRACT

Systems and methods of batch generation and delivery of customized documents are disclosed herein, comprising a process of batch populating templates to create electronic notifications that could be either archived or be transmitted to recipients that might be individuals or legal entities. Each generated electronic notification contains individual or customized information of each recipient optionally having personalized file name, personalized password protection, and personalized additional recipient. The initial templates to be populated may be in Microsoft™ Word or Adobe™ PDF format and the populated output electronic notifications may be in various format files including but not limited to Microsoft™ Word, RTF, Adobe™ PDF, Text, XML, HTML, Instant Messaging, Text messaging, Email, and the like. Complex Word or PDF forms containing checkboxes batch populated with customized data are also disclosed herein.

### CROSS REFERENCE TO RELATED APPLICATIONS

This application claims priority to U.S. provisional patent application Ser. No. 61/982,632, filed on Apr. 22, 2014 to Manijeh Behzadi, entitled “Methods and Systems for Generation and Delivery of Customized Documents,” incorporated herein by reference.

### TECHNICAL FIELD

The present disclosure is directed to methods and systems for batch generating customized electronic notifications and batch delivering the customized electronic notifications to each individual recipient using a user friendly interface.

### BACKGROUND

The need to batch generate customized and personalized documents existed for many years. Although conventional document generation systems and methods can generate personalized documents, the challenge has been to automate the document generation and delivery in batch while each document is personalized with specific data element and contents, while providing options such as personalized file name, personalized password protection, and personalized recipient. More efficient generation and delivery of personalized document is needed.

### SUMMARY

Provided herein are an apparatus for batch creating a plurality of customized emails, each email contain a primary recipient's individual information. The apparatus comprises an input unit for receiving input files from a storage unit. The input files includes an input data file, email templates, and document templates. The input data file has a plurality of field identifiers. The apparatus also comprises a structure analysis unit for analyzing the input files and extracting customized parameters, an operation instructions unit interfacing with a user, and an output unit for creating output files customized according to the customized parameters. In one embodiment, the apparatus further comprises user local programs that are operably interfaced with the apparatus. The input data file can be an excel file, a csv file, or a database file. In some embodiments, the document template can be a mapped template or content defined template. In one embodiment, the input data file is a matched input data file and the attachment template is a content defined template.

In one aspect, disclosed herein is a method for creating and sending a plurality of customized emails with optional customized attachments in batch mode. The method comprises receiving, by an input unit, input files from a storage unit, the input files including an input data file, an email template file, and document template files, the input data file having a plurality of field identifiers; extracting by structure analysis unit, the plurality of field identifiers from the input data file; creating, by an output unit, in a batch mode, customized emails, and sending, by the operation instructions unit, in the batch mode, the customized emails to designated recipients. In one embodiment, the method further comprises mapping the document template with field identifiers from the input data file. In one embodiment, the method further comprises defining content items of the document template. In one embodiment, each content items in the document template is defined with a location label. In one embodiment, the method further comprises extracting, by structure analysis unit content items from document template and tabulate in the apparatus. In one embodiment, the method further comprises matching the field identifiers in the input data file with the content items of the document template to create a matched input data file. In one embodiment, the method further comprises defining output parameters with field identifiers. In one aspect, disclosed herein is a computer-readable storage medium having computer-executable instructions for implementing the method summarized above.

In another aspect, disclosed herein is an apparatus for creating in a batch mode a plurality of customized electronic notifications, each electronic notification being customized with a primary recipient's individual information. The apparatus comprises an input unit for receiving input files from a storage unit, the input files comprising an input data file having a plurality of field identifiers and at least one template file; a structure analysis unit for analyzing the input files and extracting customizing parameters; an operation instructions unit for interfacing with a user, and an output unit for creating customized documents according to the customized parameters. In one embodiment, the apparatus further comprises user local programs that are operably interfaced with the apparatus. The input data file can be an excel file, a csv file, or a database file. The customized document can be a word document, a RTF document, a PDF document, a text document, a XML document, a HTML document, an instant messaging document, or an email document. In one embodiment, the template is a mapped template or content defined template. In another embodiment, the input data file is a matched input data file and the template is a content defined template. In one aspect, disclosed herein is a method running the apparatus described above.

In a further aspect, disclosed herein is a computer program product including a non-transitory storage medium upon which instructions are recorded that, when executed by a processor in a computer having an input unit, a structure analysis unit, an output unit, and an operation instructions unit, causes the computer to perform operations. The computer program product comprises receiving, by the input unit, input files from a storage unit, the input files including an input data file, email template files, and document template files, the input data file having a plurality of field identifiers; extracting, by the structure analysis unit, the plurality of field identifiers from the input data file; creating, by the output unit, in a batch mode, customized emails; and sending, by the operation instructions unit, in the batch mode, the customized emails to designated recipients. The computer program product is used to create customized documents.

In some embodiments, the system disclosed herein in cases where atatchments are used, not only sends email with atatchments but also saves atatchments in a user defined folder which may reside on local machine, on a company network, or on a network drive on the cloud such as One Drive, Google Drive etc. The system can generate one complex personalized or customized passwords on Word attachments. The system can generate two complex personalized or customized passwords on PDF attachments. The system can generate and save an extra copy of attachments for archive or references with no password while recipients' attachements were password protected. The system can generate subject of emails or name of Attachements based on variable name defined in the input file. Such as generating departmental emails as a group.

### BRIEF DESCRIPTION OF THE DRAWINGS

A clear understanding of the key features of the present disclosure summarized above may be had by reference to the appended drawings, which illustrate the method and system of the present disclosure, although it will be understood that such drawings depict example embodiments of the present disclosure and, therefore, are not to be considered as limiting its scope with regard to other embodiments which the present disclosure is capable of contemplating. Accordingly:

FIG. 1 is an illustration of an example showing a simplified overall view diagram of input templates, input data sources, processing and generating various outputs by the system according to various embodiments described herein.

FIG. 2A is an illustration of an example showing a simplified view diagram of a content defined template created in Microsoft™ Word according to various embodiments described herein. The system may use this template as a base to create outputs.

FIG. 2B is an illustration of an example of the methods and systems disclosed herein showing a simplified view diagram of a blank template created in Adobe™ PDF according to various embodiments described herein. The system may use this template as a base to create outputs.

FIG. 3A is an illustration of an example of the methods and systems disclosed herein showing a simplified view diagram of an input data source created in Microsoft™Excel for Employee Performance Review according to various embodiments described herein. For better views, the spreadsheet is enlarged and columns A-N and columns O-S are shown separately.

FIG. 3B is an illustration of an example of the methods and systems disclosed herein showing a simplified view diagram of an input data source created in Microsoft™Excel for IRS W-9 form according to various embodiments described herein. The left and right portions of the Excel spreadsheet is further enlarged and shown underneath it.

FIG. 4A depicts a graphical representation of user authentication and providing email and password, when attempting to use this system described herein.

FIG. 4B is a view diagram illustrating an example of main functionalities of the systems and methods after it is launched according to various embodiments described herein. The screen may be called the system Console.

FIG. 4C illustrates how data elements from Template are mapped to data elements from input data file.

FIG. 4D is a representation of how unmatched data elements are resolved and are forced to match.

FIG. 4E(a) Illustrates where the output files should reside and what naming convention for the output should be used. It further shows the selection of output format. Additionally, it shows how to configure outgoing Emails by selecting the Email template, and Email format as attached or in the body. It further allows defining the options for “To”, “Cc” and “BCc”; (b) shows how the message options may be selected from the pull down menu.

FIG. 4F shows an optional Email template that may be used for generation of Emails.

FIG. 5 is a diagram illustrating an optional embodiment of the methods and systems disclosed herein producing the output in Microsoft™ Word format according to various embodiments described herein. The system has populated the input template with appropriate data elements.

FIG. 6 is a diagram illustrating an optional embodiment of the methods and systems disclosed herein producing the output in Rich Text Format (RTF) according to various embodiments described herein. The system has populated the input template with appropriate data elements.

FIG. 7A is a diagram illustrating an optional embodiment of the method and system disclosed herein producing the output in Portable Document Format (Adobe™ PDF). The system has populated the input template which was in Microsoft™ Word with appropriate data elements and then converted it to Adobe™ PDF according to various embodiments described herein.

FIG. 7B is a diagram illustrating an optional embodiment of the method and system disclosed herein populating the appropriate blank fields in the IRS W-9 form according to various embodiments described herein, using the input data source illustrated in FIG. 3-B.

FIG. 8 is a diagram illustrating an optional embodiment of the methods and systems disclosed herein producing the output in Plain Text Format (TXT) according to various embodiments described herein. The system has populated the input template with appropriate data elements.

FIG. 9 is a diagram illustrating an optional embodiment of the methods and systems disclosed herein producing the output in eXtensible Markup Language (XML) according to various embodiments described herein. The system has populated the input template with appropriate data elements.

FIG. 10 is a diagram illustrating an optional embodiment of the methods and systems disclosed herein producing the output in HyperText Markup Language (HTML) according to various embodiments described herein. The system has populated the input template with appropriate data elements.

FIG. 11A shows an example of a block diagram of a server which may be used in the system or standalone according to various embodiments described herein. Server may be used to run various aspects and processes disclosed herein.

FIG. 11B shows an example of a block diagram of a client device according to various embodiments described herein. Client device may be used to run various aspects and processes disclosed herein.

FIG. 12A is a diagram illustrating one embodiment of the methods and systems disclosed herein producing the output as Email according to various embodiments described herein. The system has populated the input template with appropriate data elements, generated the output and attached it to the email.

FIG. 12B is a diagram illustrating one embodiment of the methods and systems disclosed herein producing the output as Email according to various embodiments described herein. The system has populated the input template with appropriate data elements, and inserted the contents of the populated template in the body of Email.

FIG. 13 is a flow chart illustrating the units of a system and its interaction with user local programs.

FIG. 14A is a flow chart illustrating one aspect of the disclosure using a system to simultaneously match content defined template with input data file and batch generate customized documents.

FIG. 14B is a flow chart illustrating one aspect of the disclosure using saved mapped template and input data file to batch generate customized documents in a system.

FIG. 14C is a flow chart illustrating one aspect of the disclosure using content defined template and matched input data file to batch generate customized documents in a system.

FIG. 15(a) shows a system screen according to one embodiment of the system disclosed herein; (b) shows a pop up structure analysis window run by the structure analysis unit; (c) shows an alternative system screen of (a) showing password options of a PDF output file; (d) shows an email template defined with customizing parameters from the pop up window of (b); (e) shows an email customized for recipient Albert Hopkins.

FIG. 16(a) shows an example raw email template; (b) is a system screen according to one embodiment of the system disclosed herein having a pop up structure analysis window; (c) is a mapped email template from (a); (d) shows an image of a folder where the input and output files are saved.

FIG. 17(a) is an example mapped Word template; (b) is mapped Word template populated with data of a specific individual Jared Garcia.

FIG. 18(a) is a raw Word template having unfilled checkboxes; (b) is the template of (a) having content items defined through Microsoft Content Control.

FIG. 19(a) is a structure analysis window in the system disclosed herein; (b) is the window of (a) tabulated with content items of FIG. 18(b) after structure analysis.

FIG. 20(a) is a portion of a second sheet of an input excel data file showing the field identifiers of a first sheet in the same input data file in column A being matched with the content items data in column B and beyond; (b) shows a portion of the sheet of (a) after all content items are matched with corresponding field identifier; (c) shows a portion of a first sheet of the input excel data file of (a) having input data listed under each field identifier.

FIG. 21 is the content items defined template of FIG. 18(b) being populated with data of a specific individual John Smith.

FIG. 22(a) is a blank PDF template having unfilled checkboxes; (b) is the template of (a) having content items defined with numeric labels.

FIG. 23(a) shows a structure analysis window tabulated with content items of FIG. 22(b) after structure analysis; (b) is the tabulated content items in the window of (a) being copied to column B and beyond in a second sheet of an input excel data file with column A filled with field identifiers of a first sheet in the same input data file;

FIG. 24(a) is a portion of the second sheet of the input excel data file of FIG. 23(b) showing the field identifiers in column A being matched with the content items data in column B and beyond; (b) shows all content items are matched with corresponding field identifier

FIG. 25 shows a first sheet of the input excel data file of FIG. 23 and FIG. 24, having input data listed under each field identifier.

FIG. 26 is the content items defined PDF template of FIG. 22(b) being populated with data of a specific customer XYZ company.

FIG. 27 shows the organization chart of a sample company.

FIG. 28 shows an email template has only very brief description in the body of the email and is used to send attachment documents.

### DETAILED DESCRIPTION

### Definitions

As used throughout, by a “recipient” is meant an individual or a legal entity.

The method and system disclosed herein relates to methods and systems for the generating customized and/or personalized and formatted electronic documents addressed and delivered to recipients. More particularly, the method and system disclosed herein relates to methods and systems for generating personalized formatted emails to individuals based on their generic and specific contents imported form input data sources.

The individual personalized and/or customized emails are usually intended for a specific recipient and may contain confidential and private information. For individuals, the information may include but not limited to salary, bonus, employment contracts, employees performance review, etc . . . and for businesses, the documents may be related but not limited to supplier contracts, dealership agreement, non-disclosure agreement, letter of intent . . . Therefore, the method and system disclosed herein is further applicable to distribution of emails with personalized and/or customized contents in various environments such as corporate offices, doctors' offices, manufacturing plants, law offices, educational institutions etc. Information pertaining to one employee or a company might differ from other employees or companies. The implementation disclosed herein has been achieved by fully automating the processes, importing data elements from input files, mapping and populating the template data to input data and generating the electronic output contents in various forms and formats, sending them to the recipients and finally archiving them without human intervention.

The need to generate customized and personalized documents has been there for many years. The challenge has been to automate the document generation while each document should be personalized with specific data element and contents. As an example, if a large corporation with over 3000 employees completes its annual employee performance review, the challenge would be how to notify each employee about his/her review and provide employees with their review details. As a result, automation of the processes would be highly desirable since it will not only save time, but will also eliminate errors. Not to mention that the delivery of notification would be extremely fast.

The major player in this space has been Microsoft™. They have been offering a mail merge program for many years and their recent offering as part of Office 2007 and later include automatic generation of documents in Microsoft™ Word format. Microsoft™ recent offering is called Microsoft™ Mailings and is a component that is integrated with Microsoft™ Word. Microsoft™ Mailings is able to use initial templates that are created in Microsoft™ Word, populate them with input data and generate output in email format with the populated template either attached to the email or inserted in the body of the email.

However, Microsoft™ Mailings is not able to generate Adobe™ PDF documents as output and also has not yet enabled the use of Adobe™ PDF forms as input templates. Furthermore, Microsoft™ Mailings is sending out the generated output emails immediately and is not saving them anywhere. If users would require Microsoft™ Mailings to save the generated emails for further references, this feature is not available under Microsoft™ Mailings. Microsoft™ Mailings can only create one large file which contains all the generated emails. The users cannot separate each individual emails if required.

As an example, in a corporation with 3000 employees, after the annual employee performance review is completed, the corporation needs to notify each employee about his/her review. If the corporation uses Microsoft™ Mailings, after it creates relevant electronic documents, it sends each individual a personalized email with the details of his/her review. However, if the organization wants to capture a copy of each individual review and save it in the individual personal file, that function is not available in the Microsoft™ Mailings. Microsoft™ Mailings can only generate one large file containing all 3000 emails which cannot be separated into individual file, unless individual copy and paste is done.

Another feature of the Microsoft™ Mailings is that it allows saving the emails by asking the user to provide the range. User can enter one individual in the range and in that case, one file for that individual would be saved. However, for 3000 employees, the process must be manually repeated 3000 times and the name of each file needs to be entered manually. It is desirable that the filename be associated with the individual name automatically but this function is not available in Microsoft™ Mailings. If the range entered is from 1 to 100, Microsoft™ Mailings creates one file which contains 100 employees and saves all of them under one large file. Again the individual emails cannot be separated.

When Microsoft™ Mailings is used for creation and generation of documents and sending emails to recipients, the system provides user with two options. First; sending email with the attachment. Second, send email without attachment but inserting the contents of the attachment in the body of email. In the case of sending email with the attachment, the body of email will be empty and Microsoft™ Mailings does provide any means to edit the body of the email and write generic or personalized content. In this situation, all the attachments sent to various recipients will have the same name and the subject of the emails to all will be the same. Microsoft™ Mailings will prompt the user to enter the subject of the email only once in the beginning and then uses that entry for all outgoing emails. Furthermore, when using Microsoft™ Mailings, attachments to the outgoing emails can only be in Microsoft™ Word format and other file formats are not allowed. Moreover, when sending emails out with or without attachments, Microsoft™ Mailings doesn't provide a facility to archive the outgoing emails. Microsoft™ Mailings also do not allow insertion of Cc and BCc in the email. When recipient receives an email generated by Microsoft™ Mailings with an attachment, after opening the email, recipient will not see any content in the email body and therefore might not know what the content of attachment might be related to, especially when attachment name is not descriptive.

In all cases, No organization as an example would agree to send personalized emails to 3000 employees prior to quality assurance of the contents and making sure all is accurate. To accomplish this, generated emails must be kept in an area for necessary examinations and validations and if OK, the system could be triggered to send the emails out to recipients and if not OK, the facility should allow for correction of some or all. Microsoft™ Mailings does not provide any means for addressing the above requirements. When using Microsoft™ Mailings, the emails are transmitted as they are being generated and those emails cannot be kept in a holding area. As a result, if there are any last minutes changes which need to be applied to the Email or the attachment, changes or correction could not be applied since all or some of the emails have already been transmitted. Furthermore, if only 20 out of 3000 reviews need to be corrected with a minor change, that will not be possible either unless the whole process is re-run and employees who received the emails be notified to discard it.

In order to be able to manage outgoing emails, there are two basic functions necessary to be able to manage the environment. First; to stop sending the emails to all or stop sending the emails for certain individual and second, allow last minutes corrections to the erroneous contents be applied and then resend. Microsoft™ Mailings does not provide any facility or functions accommodating those two requirements.

In some cases, the application using the email broadcast may require to send a copy of the email to another person, a group or an entity. As an example, in the case of employees' performance review process, the email containing the evaluation of employees and the bonus he/she is receiving needs to be forwarded to immediate manger so the manger is aware and can address any question the employee might have. Furthermore, a copy needs to be forwarded to Human Resources to be filed for future references. Microsoft™ Mailings does not allow addition the use of Cc and BCc in the email and therefore, insertion of immediate manager and/or HR in the Cc or BCc is not available. Therefore, automatic insertion of immediate manager email would not even an option.

Furthermore, customers have requested that instead of sending the populated template as part of the email body or as an attachment to the email, store it somewhere on the cloud or on-premises and then send a link to the employees. This feature is not available with Microsoft™ solution.

Organizations are also requesting that they prefer to see that the system sends the results of employees performance reviews to immediate managers first rather than sending it to the employee and let manager go over that with the employee. However, in cases like this, managers may not be available to meet with employees face to face due to their travels and would prefer if they can share the result via instant messages. This feature is not present in the current Microsoft™ solution since Microsoft™ Office does not provide any infrastructure for instant messaging (IM).

Microsoft™ solution has the capability to populate a pre-defined template which has been created in Microsoft™ Word. However, this template under Microsoft™ Solution does not have a subject. Therefore, the subject cannot be populated automatically. That is why when executing the program; Microsoft Mailings prompts the user to enter the subject.

Keeping the history of the electronic communications and archiving the documents, templates and emails sent to recipients are very important and is necessary. Microsoft™ solution does not allow any archiving capabilities which allows for individual retrieval of forms at a later time.

For security purposes, private information should be secured and some organizations prefer not to send the private information in the body of email which could be read by unauthorized individuals. Therefore, organizations may prefer to use attachments with password protection. Microsoft™ solution does not provide any password protection on the attachments. However, if organizations agree with password protection for emails instead of attachments, Microsoft™ Outlook offers that security but requires building an infrastructure of public and private key which requires extensive maintenance and support. That is why not many organizations are using that technology.

Microsoft™ solution uses mapping technique to build relationship between the input data elements and the template data elements. If the names of the data elements are different, the mapping will not be done automatically and requires manual intervention by the user. After the mapping is completed, Microsoft™ solution uses tags to insert the data element form the input into the template. However, Microsoft™ has recently introduced a new technique of inserting data elements into documents called “Content Control”. This technique could be used to collect data to be inserted into a template from the input data sources. Microsoft™ solution does not use this technique which is far superior to what was developed many years ago. As a result, the advantages of “Content Controls” are not being used in Microsoft™ solution.

Finally Microsoft™ Mailings is integrated with Microsoft Word and is a product that must be installed on a user machine (Desktop, laptop) and the user of that machine can runs the Microsoft™ Mailings program. However, for security purposes, if an organization decides to run Microsoft™ Mailings program by certain individuals within the organization and would like to enforce authentication of the user or administrator by checking their user name and password, Microsoft™ Mailings solution is unable to provide such control.

Depending on the type of industry, organizations need to regularly communicate with individuals or legal entities as their recipients. Recipients might fit in the models of Business to Consumer (B2C), Business to Business (B2B) or Business to its employees. In either case, the business is in need to communicate with its recipients.

B2C communication consists of any communication which occurs between the organization and its consumers or customers covering various subject matters. As an example, a car manufacturer would like to communicate with each consumer/customer and notifying them about a recent recall on a car they have purchased. In this example, each customer should be receiving a personalized communication explaining what kind of car the customer has purchased, when was the purchase, year and model of the car purchased, Vin# and if that car is included in the recall or not. A generic communication with the customer/consumer in this case would not be sufficient since it will not provide the detail of that customer purchase and therefore, it causes confusion for the customer not knowing if his/her car is included in the recall or not. This creates many follow up phone calls to manufacturer call center and bunch of unsatisfied customers.

B2B communication consists of any communication which occurs between two businesses. In this model, usually businesses need to communicate with each other about various subject matters. As an example, one business might be in manufacturing and other businesses may be its supplier, distributor, regional maintenance provider. The business may also be dealing with IRS on Taxes. In the case of suppliers as an example, a large manufacturer might have a generic agreement which may be duplicated many times but tailored for specific items supplied from each supplier, with customized content for a specific supplier. It would be much more effective if a system could potentially duplicate all the generic parts of the agreement and fill in all the blanks in this supplier contract template for specifics and sent it to the supplier for review and signature. Other examples might be generation of Letters of Intent, Non-disclosure agreements, and memorandum of Understandings.

In the business to employee model, communication should cover various events which occurs within the organization. Employees may include but not limited to full time and part time employees, contractors, consultants, and lobbyist.

An example would be sharing the results of an annual employee performance review with employees in a large organization with 3000 employees. After the review is completed, each employee should be notified about his/her review process, with the details of rating, salary increase, new salary, effective date, bonus amount, strengths, weaknesses, and other necessary information. The key in understanding the process is that each employee's situation is different and therefore, each employee should be receiving a customized electronic document showing the details of the review. As a result of the above, the organization needs to be able to send each employee a form or electronic document that contains all the necessary information about the review. This document is personalized and/or customized for each employee and it contains all generic as well as unique and private information for that employee.

The manual process to accomplish this task would be very time consuming and is subject to errors. Currently, many organizations struggle in doing this and they perform the task manually or semi-manually.

In one embodiments, the systems and methods disclosed herein may comprise a fully automated process of populating templates, by mapping data elements in the data files from input sources to relevant data fields in the template, retrieving and inserting data elements in their appropriate location in the template, generating populated and password protected output forms which could be either saved for future references or immediately be transmitted to recipients in electronic form that might be individuals or legal entities. The initial templates to be populated may be in Microsoft™ Word or Adobe™ PDF format and the populated output template may be in various format files including but not limited to Microsoft™ Word, RTF, Adobe™ PDF, Text, XML, HTML, Instant Messaging, Text messaging, Email, and the like.

In further embodiments, the systems and methods may comprise populating the pre-defined templates that are provided to organizations and legal entities from time to time such as PDF forms to be filled for IRS such as W-9s or W-2s.

In further embodiments, the systems and methods may comprise an automated way to populate the templates and eliminating manual processes. The method disclosed herein may particularly be suited for all Businesses that would like to communicate internally with their employees, and/or to their consumers/customers (B2C), and/or to other Businesses (B2B).

It is one aspect of the method and system disclosed herein to advance the art of communication between all parties in a timely manner and eliminates all manual work involved in traditional methods of document generation.

It is one aspect the method and system disclosed herein to streamline the process of communication in situations where numerous customized and/or personalized electronic documents, emails, links to contents or instant messages are required to be sent out to recipients, each with different contents.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

The present disclosure may be understood more readily by reference to the following detailed description of embodiments and to the Figures and their previous and following description.

### General

To better understand the details of these communications and the importance of personalized and customized communication, let's take an example of an organization that has recently completed their employee performance review process and the organization needs to notify its senior management about their bonuses.

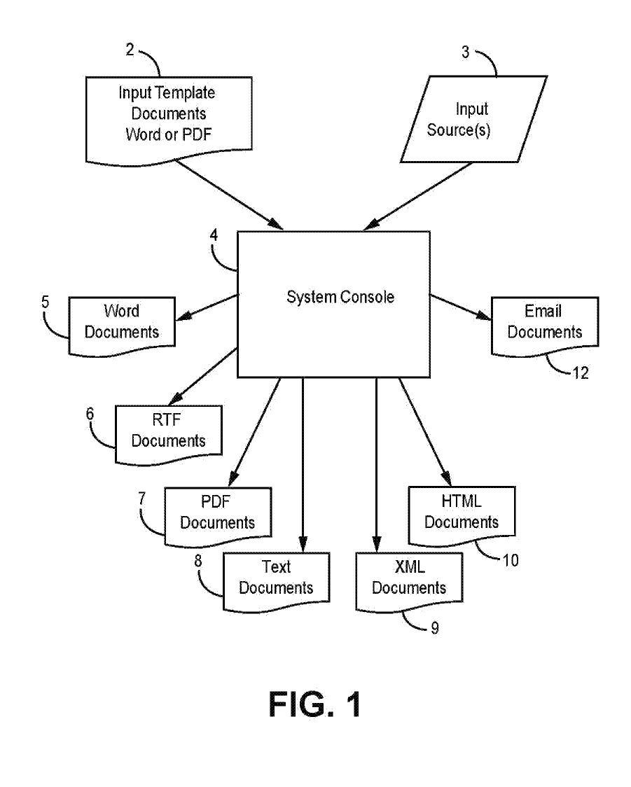

FIG. 1 depicts an example of an overall flow diagram of the systems and methods disclosed herein according to various embodiments. Using the example above, in order to be able to effectively communicate with its senior management team about their annual bonuses, the organization needs to decide what information needs to be communicated and in what format. Following that decision, the organization may create a template containing the necessary information that needs to be communicated to the recipient. To create the template, the user or administrator may use Microsoft Word to create the generic part of the template. To insert the variable parts in the template, user or administrator may want to first define a place holder for each of those variables using Microsoft Content Control.

FIG. 1 shows the input Template documents 2 that may be created in either Adobe™ PDF or Microsoft™ Word as the base for creation of the output. To populate the variable information contained in the template, the system may require using an input date file that contains such information. Input data files may already exist or be created in but not limited to databases, Excel document or CSV files. The previously created input data files should have all the required data elements in the input template otherwise; the task of generating populated templates may not be accomplished thoroughly. In cases where the input data file does not exist and should be created, the user or administrator may create an Excel spreadsheet containing the required information for all the recipients in any order. We are not going through how the spreadsheet should be created or be even copied from existing data files.

The second input data source 3 required for the system as an example may be in the form of an Excel spreadsheet as discussed above and will be shown later, or database, CSV, XML, Microsoft Word, Text or even electronic data exchange from third party APIs, and the like.

The organization should further identify what data elements are required to be collected from input data sources 3 in order to populate the template. Input data sources.

The method and system disclosed herein centers around a collection of programs, systems and methods that facilitates population of input templates and generates the output required. In FIG. 1, the system 4 comprises a set of programs that ensures the desired outcome is achieved. When the system 4 is launched and configured, it fetches the template 2 first, and then it reads from input data sources 3 and based on the users settings defined in the configuration management module, the system automatically generates one or multiple outputs for each recipient and transmits them accordingly. Output documents could be generated in various formats and stored in specified output folders by the user or administrator.

FIG. 1 depicts various output formats being generated by the system 4 as configured by the user or administrator of the system. These formats may include but are not limited to a Microsoft™ Word document 5, RTF documents 6, Adobe Portable Document Format (Adobe™ PDF) 7, Text documents 8, XML documents 9, HTML documents 10, and finally Email documents 12.

Each of these output documents could be stored or saved in an output folder. The output folder may already exist or if not, the user or administrator has the ability to create an output folder for storing the populated templates generated by the system 4. It should be noted that the output folder may be residing on Microsoft™ SharePoint, Cloud storage (SkyDrive, One Drive, Google Drive, Drop Box and the like), private storage drives, password protected storages and drives, network drives, shared drives, local or remote servers or even on administrator's local drive, or any other data storage location. One of the advantages disclosed herein over solutions in the prior art is that the output generated could be stored before they are sent out to recipients. This enables auditing the generated outputs before sending them out to recipients. Furthermore, it allows corrections to be made to a certain groups or certain individuals rather than re-running the whole workflow.

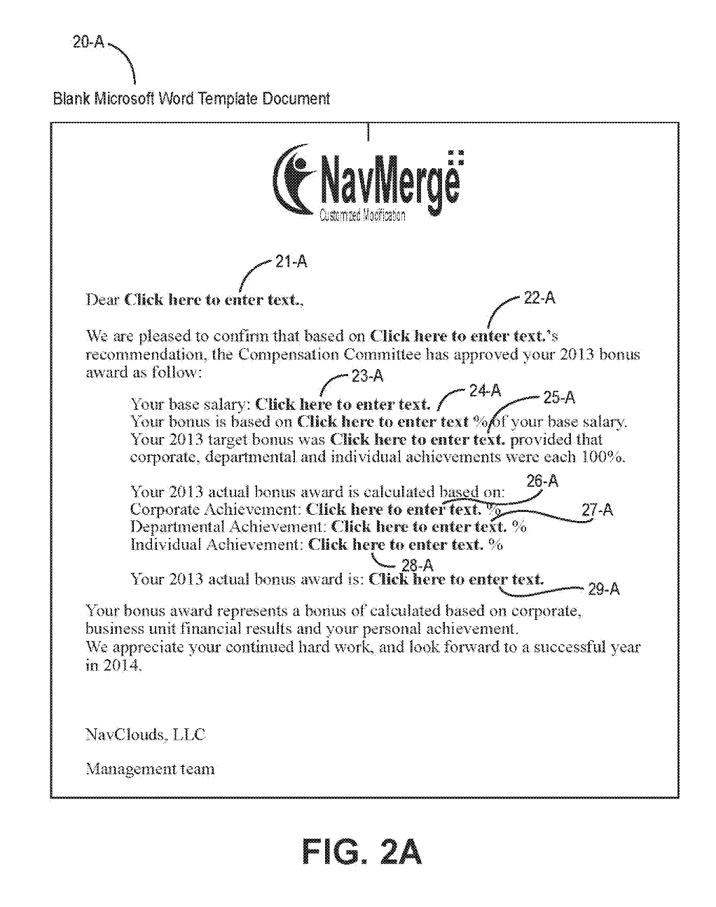

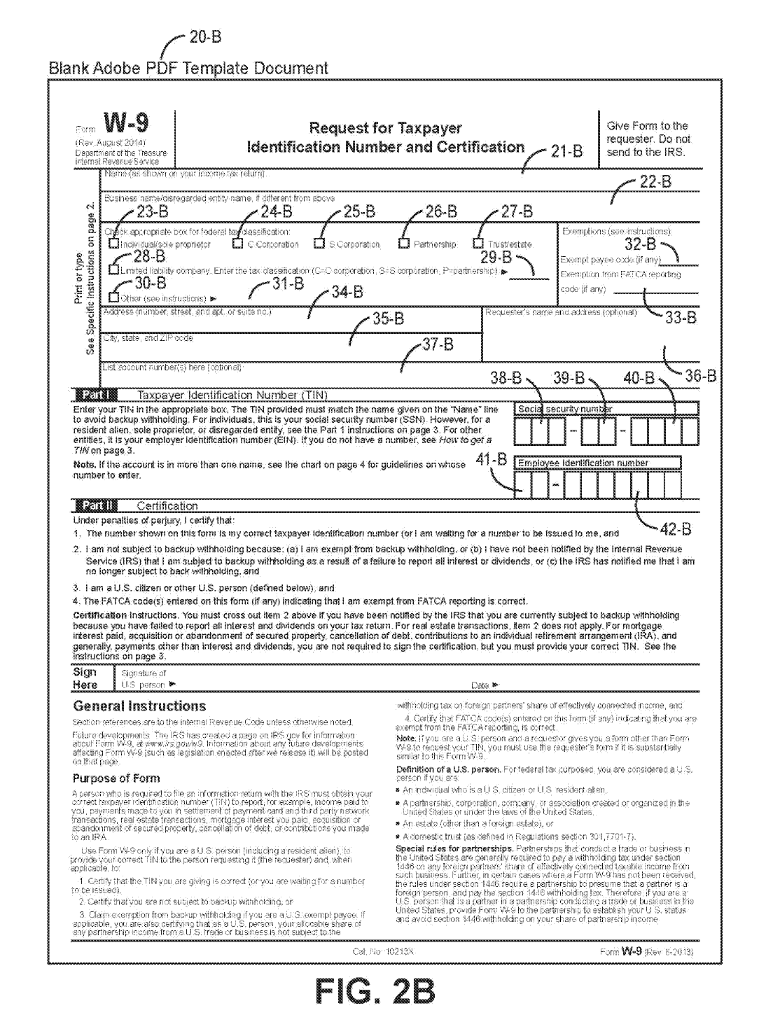

FIG. 2A shows how the input template document 20-A looks like in Microsoft™ Word file format. Full formatting of contents is possible under this format. As seen from template 20-A, there are many areas that may be filled and populated by the system. These areas are marked by “Content Control” provided by Microsoft™ and if clicked on, it allows the user or administrator to enter the requested information. However, in the method and system disclosed herein, the system will be inserting all the necessary data elements into these “Content Control” areas automatically and no manual process would be necessary. An example of using such templates would be to fill out bonus allocation of the senior management team in an organization. The biggest challenge here would be to prepare accurate form letters or emails and inform recipients about their bonus, criteria, and how it is calculated. The typical Microsoft™ Word Document template 20-A shown here contains certain data elements that should be available in the input data source(s) 3. The data elements in the template 20-A may include recipient personal and fixed data such as; first and last name of recipient 21-A, recipient manager's first and last name 22-A, recipient bases salary 23-A, recipient bonus as percent of base salary 24-A, 2013 target bonus 25-A assuming Corporate, Departmental and Individual goals were all 100% achieved.

However, in reality, Corporate, Departmental and Individuals goals may not achieve 100%. They may achieve higher or lower percentages and that would be the basis of calculation of the recipient awarded bonus. In this example, it is assumed that each goal will have an equal weight of 33.33%. Recipient bonus is then calculated based on performances achieved by Corporation 26-A, Departmental achievement 27-A and Individual achievement 28-A. Based on those variables, recipient bonus 29-A is then calculated. Template 20-A is simply one of many samples that an organization my use to communicate bonuses to recipients and the method and system disclosed herein enables and encourages organizations in using their own preferred templates. Template 20-A contains some style sheets, fonts, and formatting as could be seen. It should be noted that the system keeps all formatting and style sheets use in Microsoft™ Word document intact.

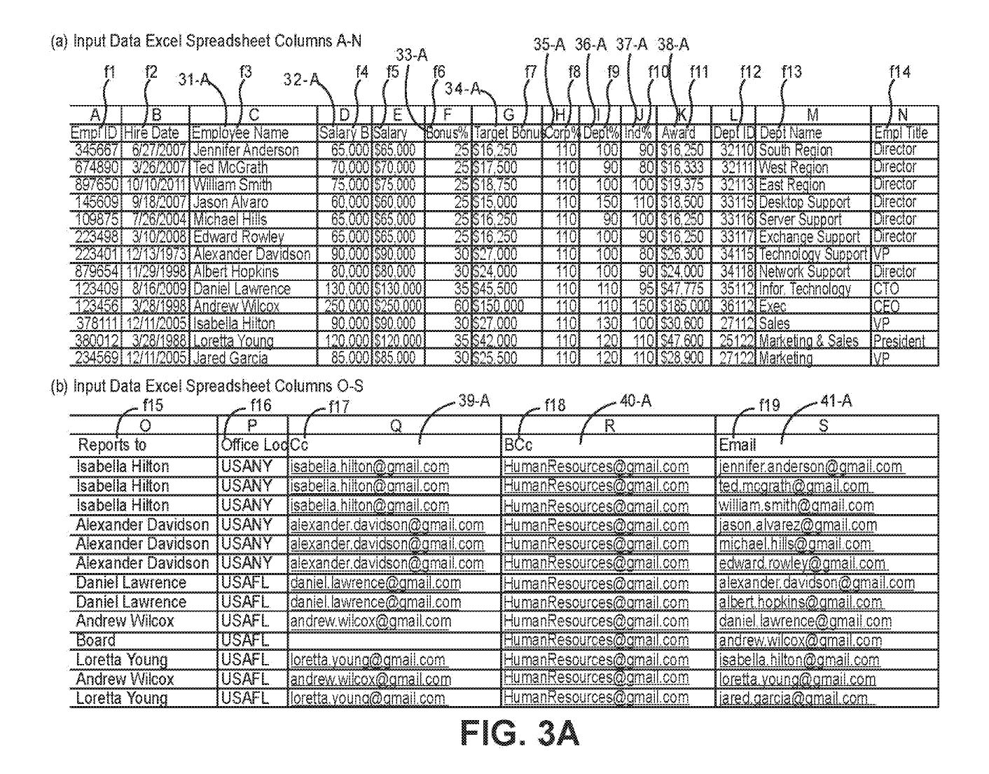

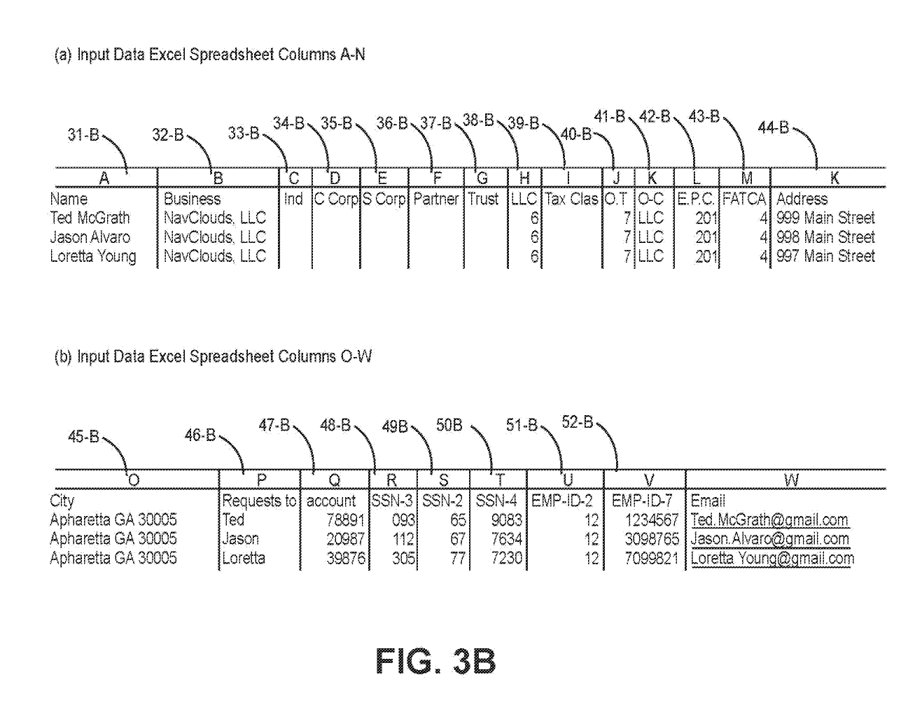

FIG. 2B shows how the template document 20-B looks like in Adobe™PDF file format. Full formatting of contents is possible under this format. As seen from template 20-B, the template has been generated in Adobe™ PDF format and only certain areas need to be filled and populated by the method and system disclosed herein. These areas are shaded in light blue color and if clicked on, it allows the user or administrator to enter the requested information. However, in the method and system disclosed herein, the systems will be inserting all the necessary data elements into these areas automatically and no manual process would be necessary. The template 20-B called form W-9 by IRS contains taxpayer information that should be filled with taxpayer information. The biggest challenge here would be to fill this form out and send it back to a recipient (an individual or a legal entity). The typical Adobe™ PDF Document template 20-B shown here contains certain data elements that should be available in the input data source(s) 30-B illustrated in FIG. 3-B. In this example, the data elements in the template 20-B include taxpayer information such as ; Name 21-B, Business name 22-B, Federal tax classification: Individual Proprietor 23-B, C Corporation 24-B, S Corporation 25-B, Partnership 26-B, Trust/estate 27-B, Limited liability company 28-B, Tax classification for (C for C Corporation, S for S Corporation, P for Partnership) 29-B, Other 30-B, Entry for Other 31-B, Exemption code 32-B, Exemption from FATCA 33-B, Address 34-B, City 35-B, Requestor 36-B, Account number 37-B, first 3 digits of social security 38-B, next 2 digits of social security number 39-B, last 4 digits of social security number 40-B, first 2 digits of employee ID 41-B, and last 7 digits of employee ID 42-B.

In FIG. 3A, an example of an input data source is shown having field identifiers f1-f19. It illustrates an example of the input data in a Microsoft™ Excel spreadsheet for our example of employee performance review and it contains data elements related to three recipients, one row for each recipient. This data source may contain all of the data elements required to populate the Template 20-A shown in FIG. 2A. Data source 30-A may contain data elements comprising Employee Name 31-A, Employee's current salary 32-A, Bonus % 33-A, Target Bonus 34-A, Corp % 35-A, Dept % 36-A, Ind % 37-A, and Award 38-A.

Further data source 30-A may comprise the recipient email 39-A. The system and method disclosed herein may accept various input data file formats such as but not limited to databases, XML, Excel, CSV, or even electronic data exchange from third party APIs.

In FIG. 3B, an example of an input data source is shown. It illustrates the input data in a Microsoft™ Excel spreadsheet for our example of IRS Adobe™ PDF pre-defined form W-9 and it contains data elements related to three taxpayers, one row for each recipient. This data source 30-B usually contains as a minimum all of the data elements required by the template that needs to be populated. The following data elements are those that may be required in the template 20-B; Name 31-B, Business name 32-B, Federal tax classification: Individual Proprietor 33-B, C Corporation 34-B, S Corporation 35-B, Partnership 36-B, Trust/estate 37-B, Limited liability company 38-B, Tax classification for (C for C Corporation, S for S Corporation, P for Partnership) 39-B, Other 40-B, Entry for Other 41-B, Exemption code 42-B, Exemption from FATCA 43-B, Address 44-B, City 45-B, Requestor 46-B, Account number 47-B, first 3 digits of social security 48-B, next 2 digits of social security number 49-B, last 4 digits of social security number 50-B, first 2 digits of employee ID 51-B, and last 7 digits of employee ID 52-B.

The system and method accepts various input data file formats such as but not limited to databases, XML, Excel, CSV, or even electronic data exchange from third party APIs.

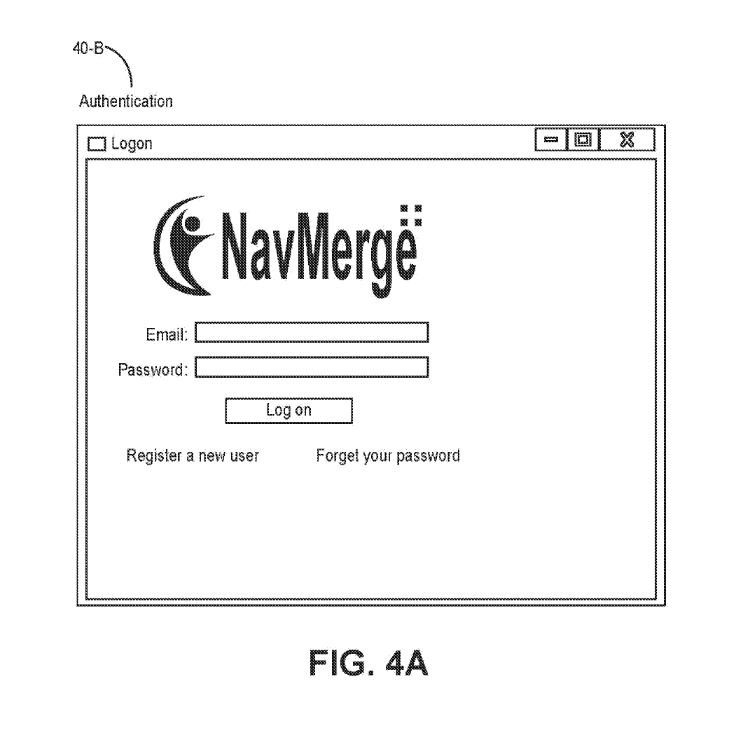

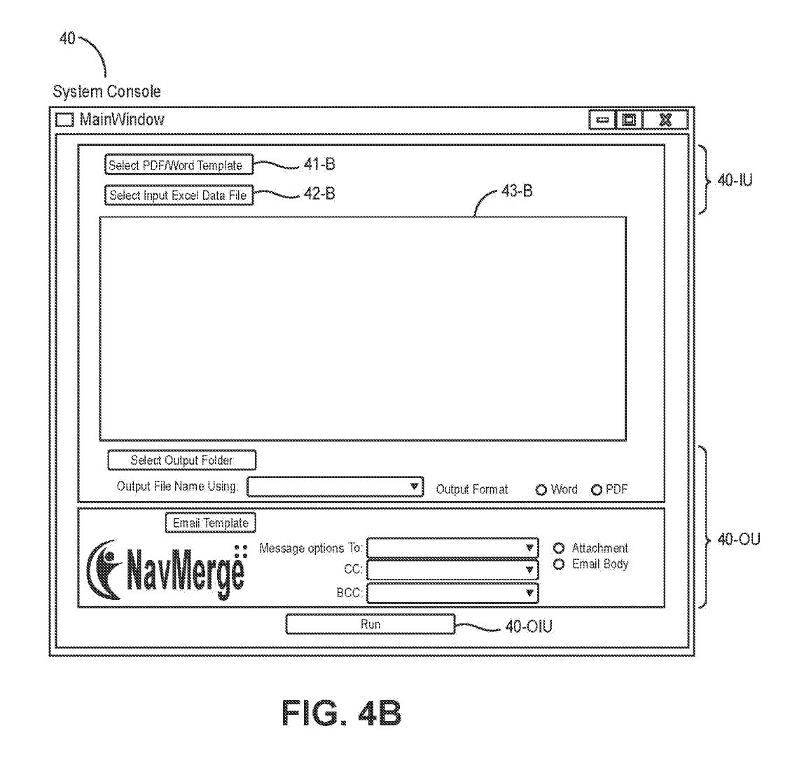

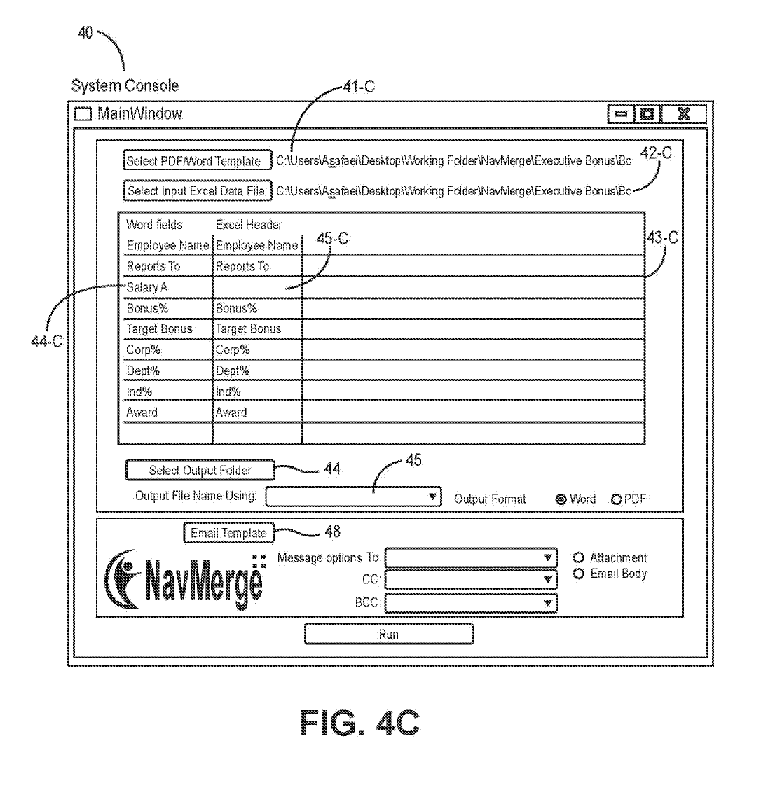

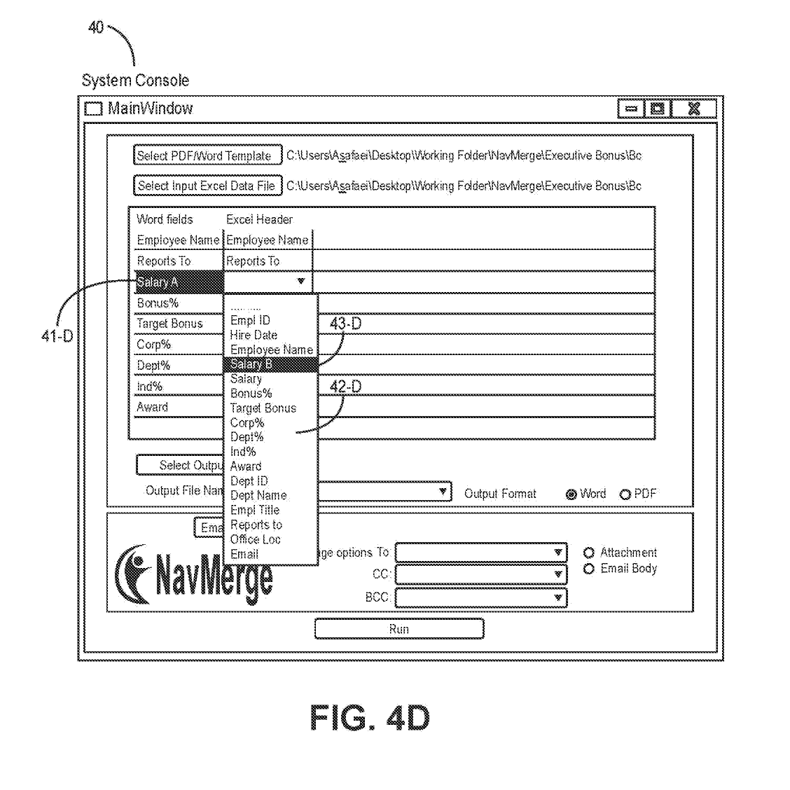

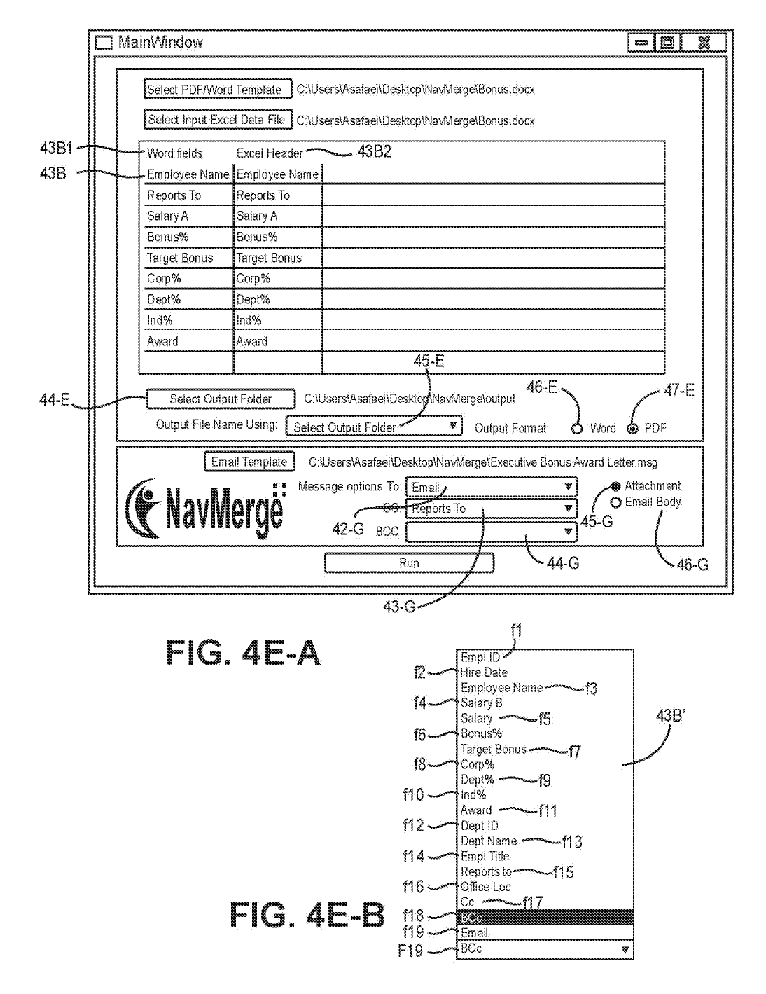

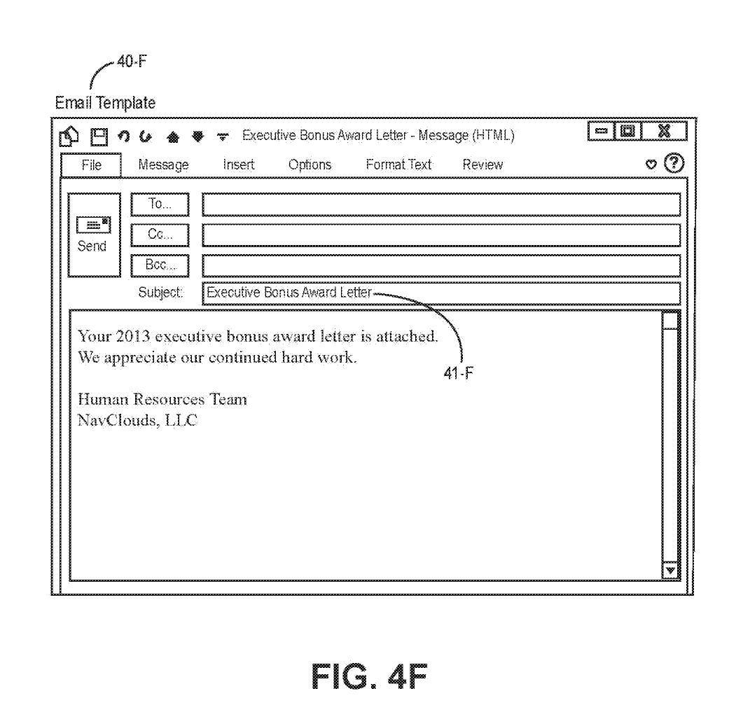

After initializing the environment for the launch of the system, in some embodiments, the systems and methods may be configured to authenticate users before granting them access. Especially when the system is being used in production environment, taking such additional security measures may be necessary and therefore, the system prompts the user or administrator with a screen 40-A for entering the Email address and password as shown in FIG. 4A. Furthermore, after authentication, the entered information may be used to determine appropriate access privileges based on the role assigned the person. Other prior arts may not have a similar security measures for authentication, and may not be offering role-based access. The method and system disclosed herein uses a role based authentication and as an example an organization may want to limit any modifications to the templates unless the role is administrator. Or creation of the location of output folder on the cloud may only be allowed by administrator. In some embodiments, the systems and methods are configured to allow role based access for multiple users. This further means that multiple users may use the system at the same time with various access privileges.

After authentication of the user, in this example embodiment, the system is launched and FIG. 4B shows a graphical interface of the system optionally called the system Console 40. The system may be installed and used locally, on premise or on the cloud. Local access may be used when a user or administrator uses his/her desktop and/or laptop machine to enter username and password and gain access to local machine. In this scenario, software runs locally and is not connected to internal network of a company (on premise) or Internet. This option is not recommended since the software updates needs to be downloaded from the network (on premise or cloud). Second may be the implementation of the system in an organization which uses its own secure network and the system is being used on-premises. Third option may be to use the cloud-based version of the system.

Since the system may be used by various departments in a company such as but not limited to Human Resources and Legal department, the system should allow multiple users and administrators access the system. Furthermore, licensing the system's software may allow for use of product in multiple locations of the organization. Therefore, the system not only should authenticate the users, but it may also check their location and roles assigned

First time use of the system software may be accomplished by downloading and installing the software which may be totally automatic and takes less than one minute.

In some embodiments, the systems and methods are configured to allows SW to be updated on the fly and optionally no need for installation. It may automatically download the new version without any interaction from the user or IT Group.

The system Console 40 is designed to assist users to locate and select input template and input data file. In FIG. 4B, the system Console 40 allows users to configure what is to be inputted to the system and what is to be outputted from the system. In some embodiments, the system Console 40 may comprise the following; Select Adobe™ PDF/Word Template button 41-B when clicked, allows the user to locate and select the path where the input template is residing. This further signals the system that the selected file should be used as an input template and needs to be populated. The input template might be in Adobe™ PDF (usually created by third parties such as IRS) for W-9 or any organization's created template in Microsoft™ Word, Adobe™ PDF or any other format available. The system accepts templates in Microsoft™ Word, Adobe™ PDF and after populating them with input data, the system can generate populated output in Microsoft™ Word, Adobe™ PDF, Text, IM, Email Body, or Email with attachments. It also can save output in the cloud or in any other storage location and provides a links to the recipient. Current prior arts however, can only accept Microsoft™ Word as input template and when the template is populated, it can generate output in Email or Email with attachment in Microsoft Word format only. The second input file in our example here would be the input data file. When the user or administrator of the system clicks the Select Input Excel Data File 42-B button, the system displays a directory path for user or administrator to locate and select the input data file. As soon as the input data file is selected, the system automatically starts reading data elements from the template 41-B (FIG. 4B) to the data elements which were read from input file 42-B (FIG. 4B), and maps the two sets of corresponding data elements, and prompts the users with mapping results.

FIG. 4C illustrates the mapping results in system console 40. Matched data elements as well as one data element that didn't match are shown. The mapping default is based on the name of data elements. Any data element in the input template which has an exact name match in the data element in the input data files are resolved. If the names are not the same, mapping cannot be resolved. The outcome of this process populates the space 43-C (FIG. 4C) with a table. The table clearly shows a mismatch 44-C. The template shows Salary A, 44-C but the input data file shows a blank data element 45-C. This further indicates that there was no data element in the input data file with the name of “Salary A”.

FIG. 4D shows how the matching may be resolved manually. In the system Console 40, the user or administrator may use the pull down 42-D that is associated with input data elements and selects Salary B 43-D which may is the equivalent data element to Salary A.

At this time in FIG. 4E, the user or administrator may be required to use the system Console 40 to locate and select the output folder 44-E. The output folder either already exists which in this case will be selected or if it doesn't exist in the desired location, the administrator will create it first and then selects it. This is the folder where the entire populated output template will be kept for both further validation and transmission to recipients or may be used as archive.

At this time, and after the output folder is selected, the user or administrator should select the output filename 45-E. The system Console 40 provides a pull down menu where the data elements are displayed and may be selected. The relevant data elements might be Empl ID, Employee Name, Empl Title or Employee Email. In this example, if Employee Name is selected, it means that for all generated output files, the filename would be the Name of recipients.

Further selection relates to output format which may be radio button Word 46-E, PDF 47-E, or other radio buttons not shown here, such as but not limited to XML, Text and the like.

Up to this point, the administrator has configured the system Console 40 for generating the populated output template in either Microsoft™ Word or Adobe™ PDF and has defined an output folder where the generated document may be stored. This process by itself is complete. The users or administrator can now go to the output folder, open the generated (populated template), examine the contents for accuracy and if approved either print, or attach them to an email or provide a link of them to the recipient. These processes may require and comprise of manual processes.

FIG. 4E further illustrates how the system Console 40, allows user or administrator to locate and select the desired Email template. Furthermore, in addition to saving the populated template in the output folder, the user or administrator may prefer to attach the output to the email or incorporate it in the body of Email. In the message option there are three email addresses that may be selected by the user or administrator. First is “To” 42-G. When clicked on the button to the right of “To”, a pull down appears and allows selection of a data element. In this case the appropriate selection may be the “Email”. This further means that the generated Email will be sent to the email address in the Email field in the input data file. If there are multiple email addresses in that field, the email will be sent to multiple individuals or legal entities.

Second option is “Cc” 43-G, which is the carbon copy and it means copy of emails should be sent to multiple the individual(s) or legal entities. This further means that the generated Email will be copied and sent to the email address in the Cc field in the input data file. If there are multiple email addresses in that field, the email will be sent to multiple individuals or legal entities.

Third option is “BCc” 44-G, which is the Blind carbon copy and it means copy of emails should be sent to multiple the individual(s) or legal entities with the original receiver knowing it. This further means that the generated Email will be copied and sent to the email address in the BCc field in the input data file. If there are multiple email addresses in that field, the email will be sent to multiple individuals or legal entities.

Usually the Cc and BCc may be used for archiving and filing purposes. It may also be used for information and awareness of the receiver. It is further assumed that the input data file 30-A (FIG. 3-A) contains the appropriate fields for Email 42-G, Cc 43-G, and BCc 44-G.

Furthermore, in this embodiment, the user or administrator may select the output format of the Email. There are two options to select from that are presented by radio buttons. First is the attachment 45-G. This means when generating email, include the personalized contents as an attachment to the Email. Second option might be Email Body 46-G. This means no attachment would be necessary and the personalized contents of the recipient may be incorporated in the body of Email. At this time the configuration and set up of the system Console 40 is completed and by clicking on Run button 47-G, the requested templates will be fully populated and will be either saved in the output folder or the draft folder of Microsoft Outlook.

The output generated in the form of Email is saved in the draft folder of Microsoft Outlook and now they may be sent automatically immediately after creation or may be sent with a delay so the user or administrator will have enough time to validate the outgoing emails for accuracy and possible last minute correction. In some embodiments, the systems and methods are configured to allow user or administrator the ability to click a button (not shown here) and send all emails saved in the draft folder out to recipients. Depending on the case, the user may open one or multiple Emails in the draft folder and make changes or corrections as necessary and save them back. Emails in the draft folder may be sent individually or by group or all of them at once. Opening an email in the draft folder is similar to any other email and as we all know and may be edited as it is required and saved.

While the Emails are sitting in the draft folder of Microsoft Outlook, the user or administrator may decide to stop sending out one or a group or all of the emails. To accomplish this, user or administrator may open the draft folder of the Outlook and look for the email that needs to be stopped and delete them or move them to another directory before sending the rest of the Emails out. It is assumed that the emails are named after the recipient or coded with group identifications and it would be easy to locate one or a group of emails. If there are problems with all the outgoing emails, then the user or administrator may prefer to fix the problem in the template or fix the process of generating output file. After generating the output, the system allows the user or administrator to select the output location. Assuming either Microsoft SharePoint or Google Drive is chosen as an example, during the saving process, the system is able to assign access to all users who will be receiving emails. After completion of this step, the Emails to recipients may be generated with a secure link to the output file. In this embodiment, there is no need to send the contents as an attachment or in the body of Email.

However, the user or administrator may decide to eliminate the manual processes of sending the populated output to recipients, and instead send the output files generated via direct Emails to Recipients. In some embodiments, the systems and methods are configured to allow creation of customized and personalized email body for recipients (individuals and legal entities). To do this, the user or administrator may use an Email template 40-F shown in FIG. 4F. The template has a subject 41-F that when filled, all emails generated will have the same subject and there will be no need for the user to be prompted to enter the Email subject. This subject may be edited as necessary. The system can attach the populated output templates to this Email template and populate all other necessary variables such as To, Cc and BCc. In some embodiments, the systems and methods are configured to allow changing a plurality of specific outgoing emails for individuals and legal entities as well. If the change is more generic and should be included in all outgoing emails, then email template may be edited, which will change the content(s) of all outgoing emails. If necessary, the user or administrator can edit a group of email or an individual email for subject or body or both, this could be done by opening the email in the draft folder of Microsoft Outlook. There are instances where one or a few outgoing emails need to be corrected with last minutes changes. The systems and methods disclosed herein allow full editing of the email content before sending them out.

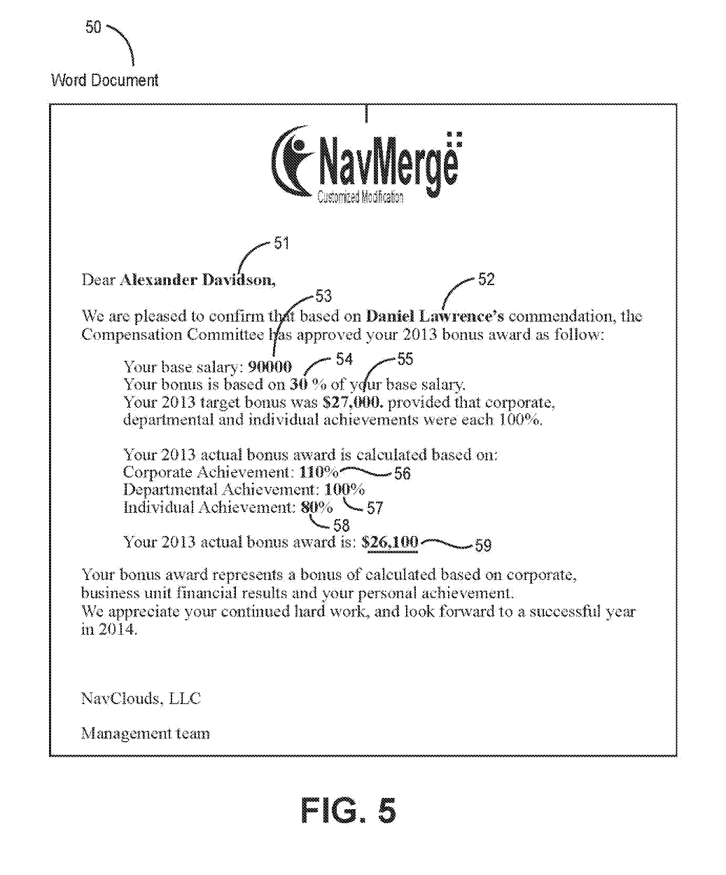

FIG. 5 further illustrates an example of a populated Microsoft™ Word document sample 50 generated by the system for Alexander Davidson. The appropriate data elements that have been inserted in the Microsoft™ Word Document Sample 50 include; name of recipient 51 (Alexander Davidson), recipient managers name 52 (Daniel Lawrence), recipient base salary 53 ($90,000), recipient bonus percent 54 (30%), recipient 2013 target bonus 55 ($27,000), corporate goal achievement 56 (110%), departmental goal achievement 57 (100%), individual goal achievement 58 (80%) and recipient 2013 actual bonus award 59 ($26,100). The system described herein may generate one personalized Microsoft™ Word Document for each recipient which is based on input data file. Since this document is in Microsoft™ Word, it may be edited. The system described herein also provides full capabilities to apply a plurality of style sheets and formatting to the content of the document being generated. As seen, all populated data elements are bolded and all bonus and salary numbers have a $ sign. Further style sheet is applied to 2013 actual bonus award 59 by underlining the bonus amount.

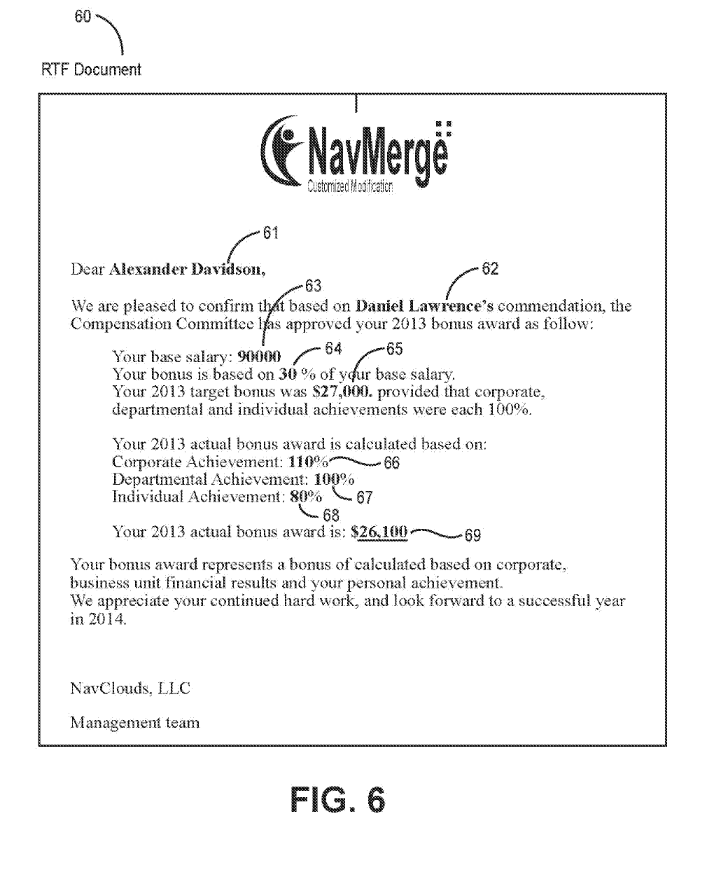

FIG. 6 further illustrates an example of a populated RTF document sample 60 generated by the system described herein for Alexander Davidson. The appropriate data elements that have been inserted in the RTF Document 60 include; name of recipient 61 (Alexander Davidson), recipient managers name 62 (Daniel Lawrence), recipient base salary 63 ($90,000), recipient bonus percent 64 (30%), recipient 2013 target bonus 65 ($27,000), corporate goal achievement 66 (110%), departmental goal achievement 67 (100%), individual goal achievement 68 (80%) and recipient 2013 actual bonus award 69 ($26,100). The system described herein may generate one personalized RTF Document for each recipient based on input data file. Since this document is in RTF, it may be edited, contents could be modified and errors may be corrected before sending it out. The system described herein also provides full capabilities for applying a plurality of style sheets and formatting to the content of the document being generated. As seen, all populated data elements are bolded and all bonuses and salary numbers have a $ sign. Further style sheet is applied to 2013 actual bonus award 69 by underlining the bonus amount.

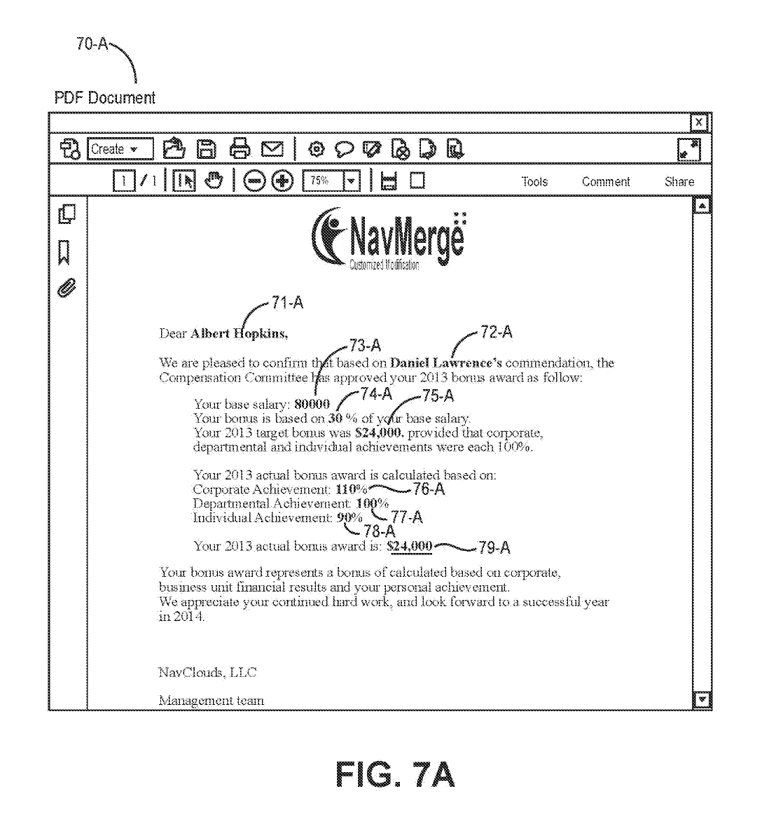

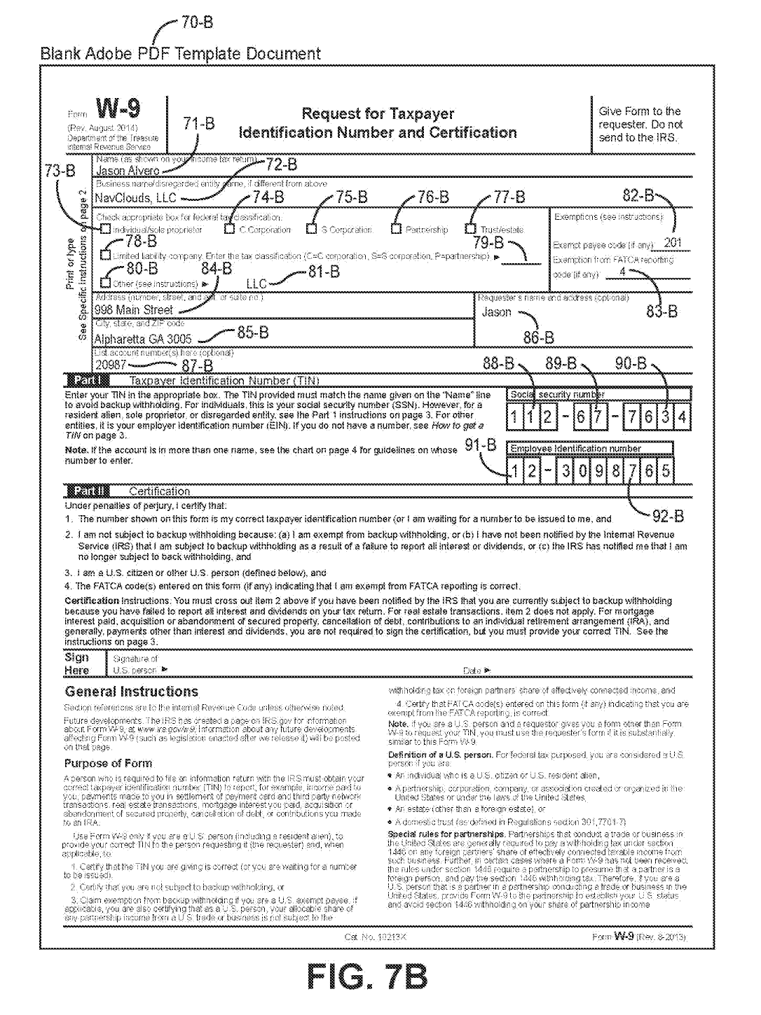

FIG. 7A further illustrates an example of a populated Adobe™ PDF document sample 70 generated by the system described herein for Albert Hopkins The appropriate data elements that have been inserted in the Adobe™ PDF Document 70 include; name of recipient 71-A (Albert Hopkins), recipient managers name 72-A (Daniel Lawrence), recipient base salary 73-A ($80,000), recipient bonus percent 74-A (30%), recipient 2013 target bonus 75-A ($24,000), corporate goal achievement 76-A (110%), departmental goal achievement 77-A (100%), individual goal achievement 78-A (90%) and recipient 2013 actual bonus award 79-A ($24,000). In this example, the awarded bonus is calculated based on the equal weight given to corporate, departmental and individual goals achievements and each will have a weight of 33.33%.

The system described herein may generate one personalized Adobe™ PDF Document for each recipient based on input data file. Since this document is in Adobe™ PDF, it may not be edited and is read-only. The system described herein also provides full capabilities for applying a plurality of style sheets and formatting to the contents of the document being generated. As seen, all populated data elements are bolded and all bonuses and salary numbers have a $ sign. Further style sheet is applied to 2013 actual bonus award 79-A by underlining the bonus amount.

FIG. 7B shows how an example of a blank Adobe™ PDF template 20-B (FIG. 2B) looks like when it is filled with relevant data elements and is populated 70-B. This is just an example of how the system described herein populates pre-defined Adobe™ PDF documents automatically by using the input data source 3 (FIG. 3-B). Full formatting of contents and application of style sheets are possible under this format. As seen from template 20-B, the template has been generated in Adobe™ PDF format and only certain areas need to be filled and populated by the method and system disclosed herein. These areas are shaded in light blue color and if clicked on, it allows the user or administrator to enter the requested information. However, in the method and system disclosed herein, the system described herein may insert all the necessary data elements into these areas automatically and no manual process would be necessary. An example of using such templates would be to fill out Taxpayer information into IRS for W-9. There would be quite a challenge when large quantities of these forms need to be filled in a short time with no errors. The typical Adobe™ PDF Document template 20-B shown here contains certain data elements that should be available in the input data source(s) 30-B (FIG. 3-B). The data elements in the output form which were automatically filled by the system described herein may include; Name 71-B, Business name 72-B, Federal tax classification: Individual Proprietor 73-B, C Corporation 74-B, S Corporation 75-B, Partnership 76-B, Trust/estate 77-B, Limited liability company 78-B, Tax classification for (C for C Corporation, S for S Corporation, P for Partnership) 79-B, Other 80-B, Entry for Other 81-B, Exemption code 82-B, Exemption from FATCA 83-B, Address 84-B, City 85-B, Requestor 86-B, Account number 87-B, first 3 digits of social security 88-B, next 2 digits of social security number 89-B, last 4 digits of social security number 90-B, first 2 digits of employee ID 91-B, and last 7 digits of employee ID 52-B.

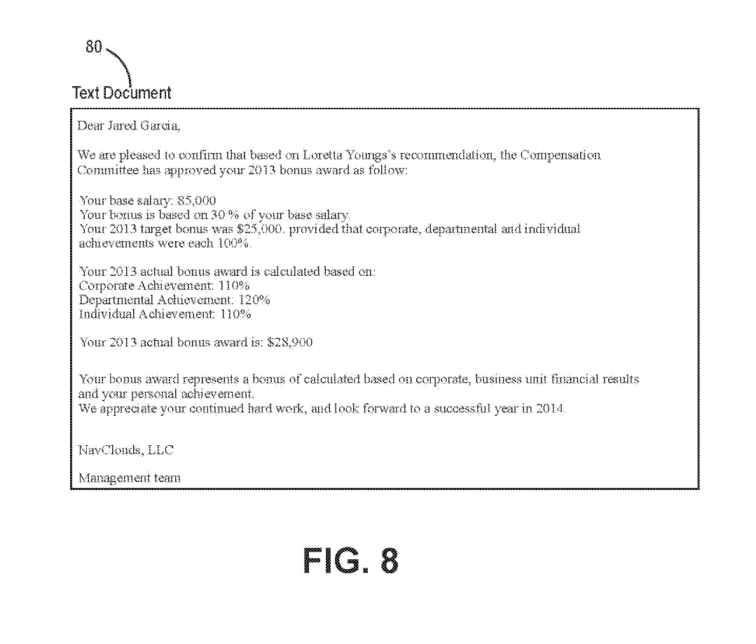

FIG. 8 further illustrates an example of a populated Plain Text document 80 generated by the system described herein for an individual such as Jared Garcia. The appropriate data elements that have been inserted in the Text Document 80 is the same as the one discussed and referenced in FIG. 5 and FIG. 6 and will not be repeated here. As seen the recipient is a different individual and therefore has a different manger, Loretta Young, and the rest of inserted data elements are different from previous examples shown in FIG. 5 and FIG. 6. Since this document is in text, it may be edited. In some embodiments, the system may not provide any capability for applying style sheets and formatting to the content of the text document being generated. As a result, no bolding or underline has been applied in this example.

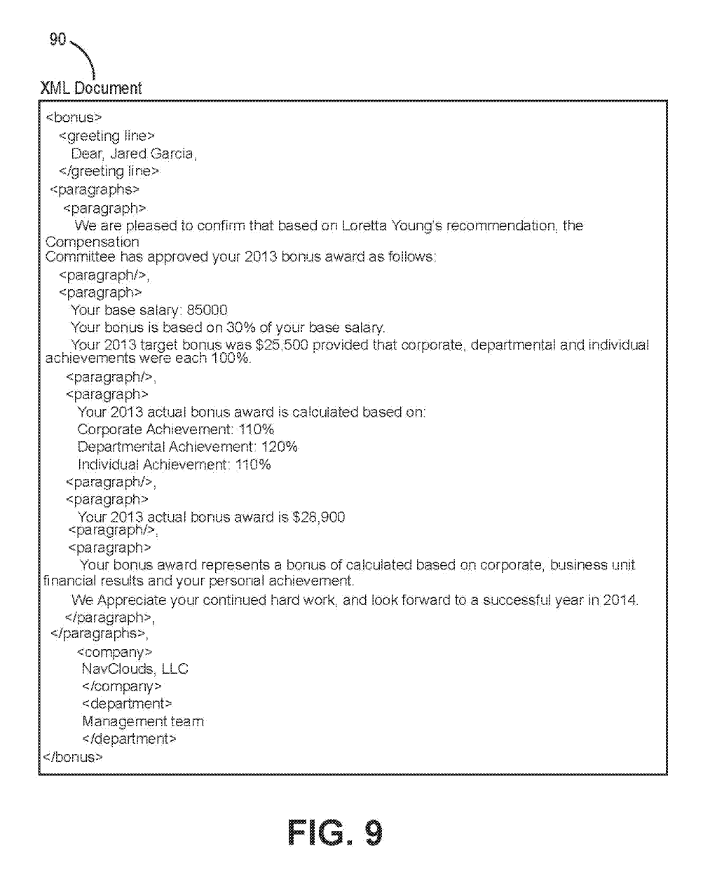

FIG. 9 further illustrates an example of a populated XML document 90 generated by the system described herein for Jared Garcia. The appropriate data elements that have been inserted in the XML Document 90 is the same as the one discussed and referenced in FIG. 5 and FIG. 6 and will not be repeated here. Since this document is in XML, it may be edited.

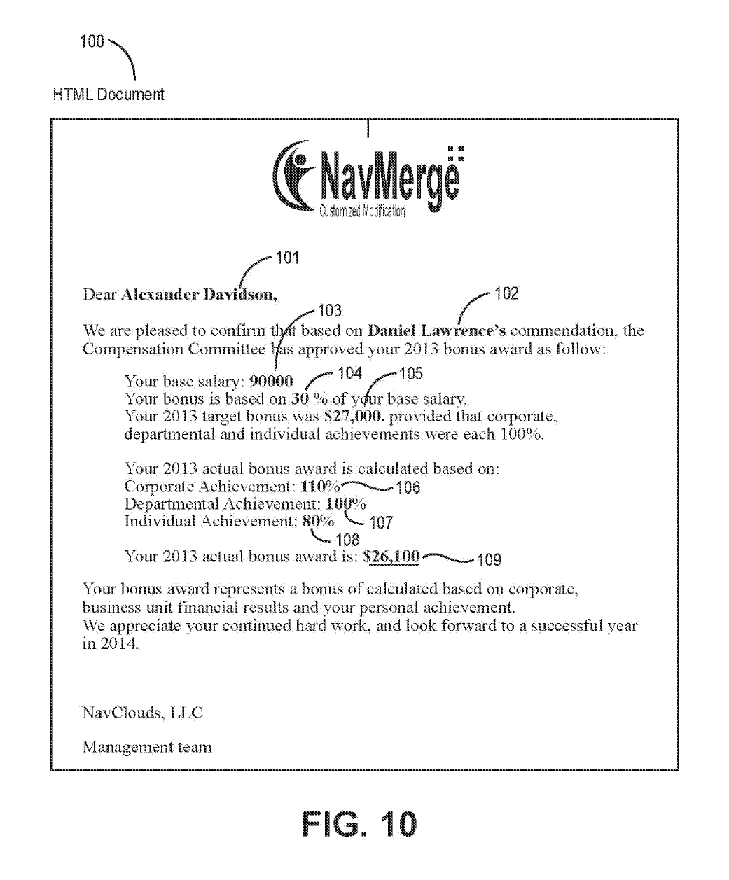

FIG. 10 further illustrates an example of a populated HTML document 100 generated by the system described herein for Jared Garcia. The appropriate data elements that have been inserted in the HTML document 100 (FIG. 10) is the same as the one discussed and referenced in FIG. 5 and FIG. 6 and will not be repeated here. Since this document is in HTML, it may be edited.

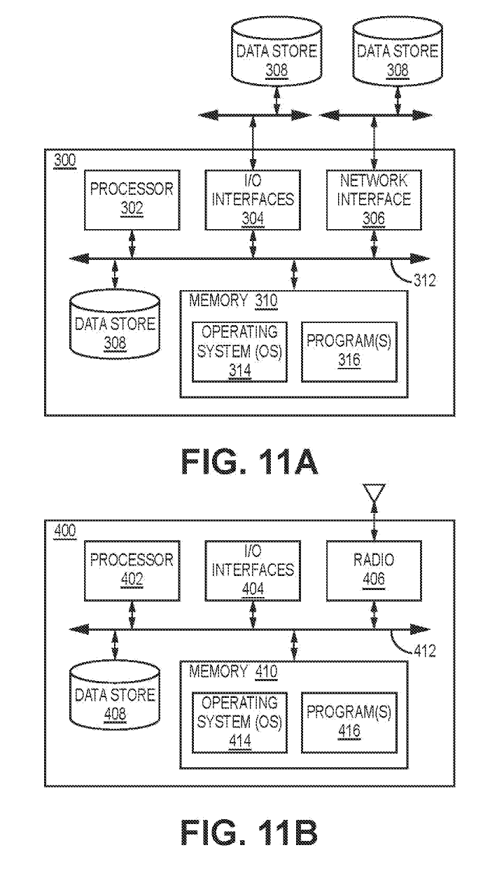

Referring to FIG. 11A, a block diagram illustrates an example server 300 which may be used in the system 200, in other systems, or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 11A depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, a wide area network (WAN), a local area network (LAN), and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

Referring to FIG. 11B, a block diagram illustrates an example mobile device 400, which may be used in the system 200 or the like. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 11B depicts the mobile device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 400, a semiconductor-based microprocessor (in the form of a microchip or chip set), or generally any device for executing software instructions. When the mobile device 400 is in operation, the processor 402 is configured to execute software stored within the memory 410, to communicate data to and from the memory 410, and to generally control operations of the mobile device 400 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 400. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 4, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with a network such as the system 100.

In one embodiment, the methods and systems disclosed herein produce the output as Email. The system has populated the input template with appropriate data elements according to various embodiments described herein. Furthermore, in this embodiment, the system generates an email addressed to recipient(s) with the option of incorporating the populated template data either in the body of email or as attachment to the email according to various embodiments described herein. For example, when generating email, it is necessary to select if the populated template needs to be attached to the email or if the populated template contents be incorporated in the body of Email. The system disclosed herein has the built-in capability to allow users to decide on the type of Email being generated. User or administrator may choose emails being generated with the populated template as an attachment or emails being generated without template which means the contents of the populated template should be inserted into the body of email.

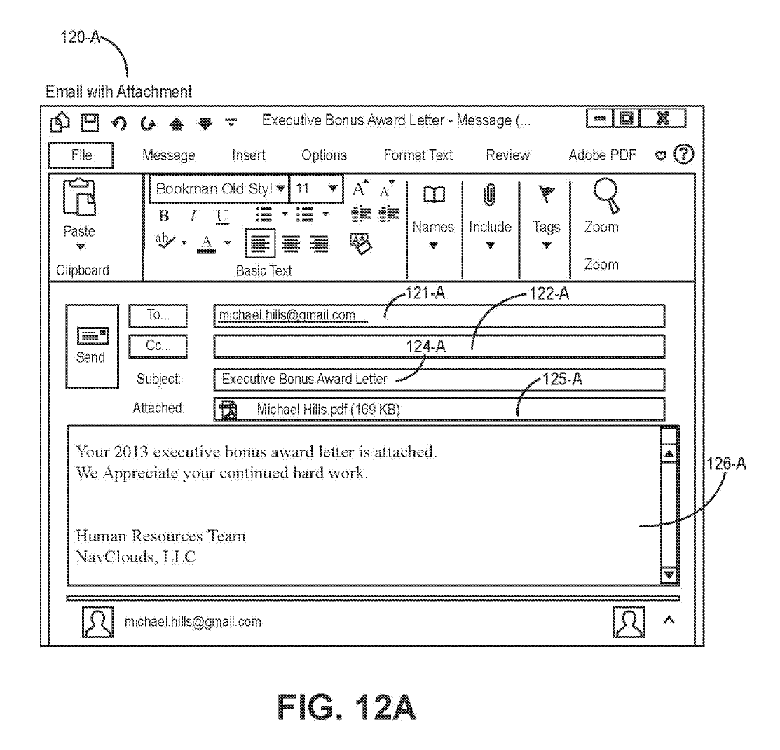

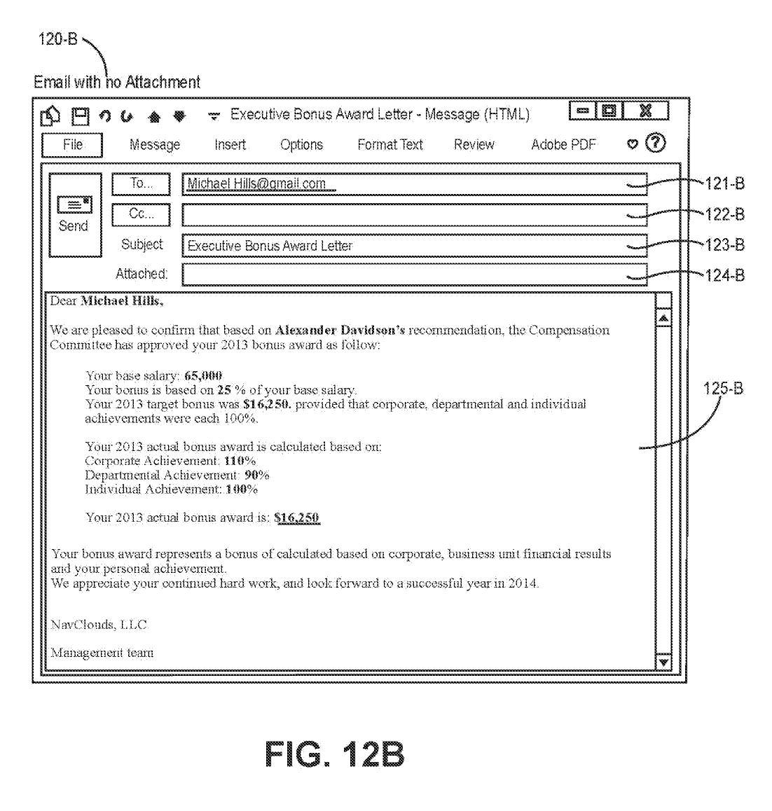

FIG. 12A illustrates an example of an Email generated with an attachment 120-A. In some embodiments, the systems and methods are configured to allow password protect the attachments to make it more secure. Organization may prefer password protected attachments over incorporating the contents in the email body.

The components of the generated email are; “To” field 121-A which not only allows for recipient name but it also, allows other recipients to be receiving emails. Cc Field 122-A is designated for carbon copy and BCc field 123-A (not shown) for blind carbon copy recipients. The system described herein allows insertion of email recipients in Cc and BCc automatically.

Subject field 124-A is populated from the original email template and could be edited if necessary. Attached field 125-A is where the system described herein automatically places the populated template. In some embodiments, the User or administrator has three options for attachment that could be either in Microsoft™ Word, Adobe™ PDF, or Text. This selection is made at the time of executing the system described herein and is included in the system. Default for the system console described herein could be set to Adobe™ PDF if necessary to ensure the contents of template cannot be edited by accident. Furthermore, the attachment name is generated by the system described herein and could be anything decided during the configuration. This naming convention is extremely important in cases where there are other recipients on the email in (To, Cc, BCc) who receives numerous emails but needs to know what that attachment is related to. The attachment, when opened, may look like what was shown in FIG. 5 through FIG. 11 and FIG. 12A and FIG. 12B, depending which output format was used.

Furthermore, if the file name is associated with recipient name, any last minute changes could be done very quickly before it is sent out. An additional feature of the method and system disclosed herein is that when the emails are generated, they may be intentionally stored in the draft folder of Microsoft™ Outlook before they are sent out. Microsoft™ Outlook is simply an example and the system described herein can work with other email systems as well. This feature allows the user or administrator of the system to implement an audit and validation process and correct any last minute errors before the emails are sent out.

Another important feature of methods and systems disclosed herein is the ability for the user or the administrator to edit and modify the text in the body of emails. The text associated with the body of email may be stored in a file with an extension of .msg. When editing this file, the administrator or user can use a full style sheet and apply any formatting required. In addition to the recipient name which is personalized in this email, all other recipients in the To, Cc and BCc could be personalized based on their relation to the recipient. As an example, if the system described herein is used in an organization for notifying employees on performance reviews, a manager of certain recipient is supposed to receive a copy of the email and the attachment, that manager's name would not be the same for all recipients and The system described herein may be configured to insert the email address of the immediate manager(s) for a corresponding employee recipient. The attachment in this email may also be personalized and its content changed to correspond from one person to another. Furthermore, when using the email template, the administrator may insert email addresses of various recipients in the Cc and BCc fields. In this case, when the administrator uses the system Console and assigns certain email addresses to the Cc and BCc fields, the ones in the system console described herein gets higher priority and therefore, The system described herein may removes the email addresses already defined in the template. This feature is extremely important when a copy of all the emails needs to be sent to an email address in the Human Resources or for the archive in an organization. In some embodiments, the administrator may make sure to insert that email in the BCc of the template and make sure it is not overwritten at the time of configuring the system Console. The Email attachments may be in Microsoft™ Word, or Adobe™ PDF. Another security matter would be how to protect private information being sent in the attachments. To protect recipients, the system console described herein may be configured to protect the attachment by a password which may be automatically generated by the system described herein and embedded into the attachment. As an example, if Human resources requires, a generated password might be the combination of last 4 digits of recipient social security number combined with employee ID. The system described herein now uses this password to encrypt the content of attachment. The system described herein may also send the password via SMS to the recipient mobile device which recipient uses it to decrypt the attachment.

FIG. 12B illustrates an example of an Email generated without any attachment 120-B. The reason for this option may be to eliminate creation and naming of the attachment and as a result, recipient is not required to open an email attachment. In some cases even, the recipient might not have the necessary software or the latest version to be able to open the attachment. To accomplish this, the system may insert the content of the attachment in the body of the email if preferred. This way, when using HTML the system may keep all formatting and graphics and at the same time, the recipient will not have any problem reading it since there will be no attachment. Other features of the system console described herein for formatting and application of style sheets will be granted here as well and multiple recipients in To, Cc and BCc will be allowed. File naming convention for the email itself will also be allowed so emails could be distinguished from each other by first name and last name of the main recipient.

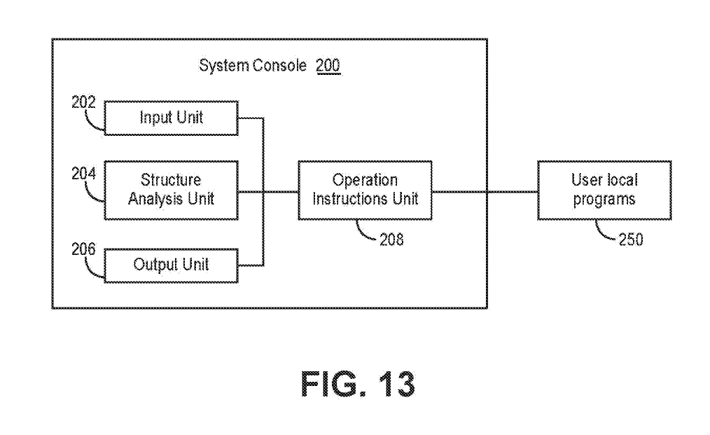

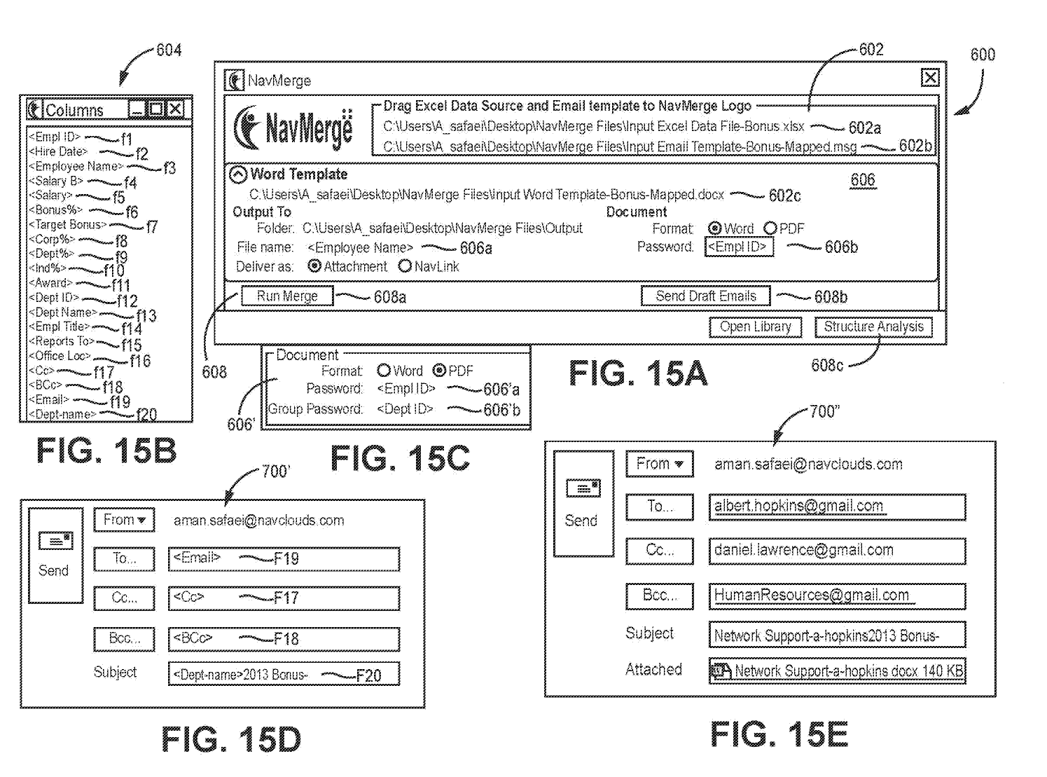

Referring to FIG. 13, a schematic diagram of a system 200 is shown. The system 200 comprises an input unit 202, a structure analysis unit 204, an output unit 206 and an operation instructions unit 208. The system 200 interfaces with programs 250 on the user's local computer. User local programs 250 can include for example, Microsoft .NET Framework 4.5, Windows 7 or later and Microsoft Office. In one embodiment, Word, Excel and Outlook may be required to be configured and be up and running on the user local computer while the system is in operation. Throughout the application, the phrase “system console” is used to describe a user interface to the units in FIG. 13. Referring to FIG. 15, an example system console is shown having an input interface 602 interfacing with input unit 202, a structure analysis window 604 interfacing with structure analysis unit 204, an output interface 606 interfacing with output unit 206 and operation instructions interface 608 interfacing with operation instructions unit 208. An alternative embodiment of system console is shown in FIG. 4B. Referring to FIG. 4B, a system console 40 is shown to have an input interface 40IU, a structure analysis interface 43B, an output interface 40OU and an operation instructions interface 40OIU. The input unit 202, the structure analysis unit 204, the output unit 206, and the operation instruction unit 208, though depicts as separate units, they can be implemented physically as one single unit or several physical units. They can also be implemented through software implementation by having different set of instructions executed by a microprocessor.

The input unit 202 in FIG. 13 is designed for receiving input files such as input data file and various template files. The input data file contains input data that is needed to populate a template such as individual information of all primary recipients and yes or no options for checkboxes. Data in the input data file are organized under field identifiers such as f1, f2, f3, . . . fn. The input data file can be an excel file, a csv file, or a database file. In one embodiment, the input data file is an excel file having field identifiers f1, f2, f3, . . . fn. Referring to FIG. 3A, an example excel spread sheet as an input data file is shown having field identifiers f1-f19 and corresponding input data listed under each field identifier. The input interface 602 in FIG. 15 is shown to have input data file 602a, email template 602b, and document template 602c loaded.

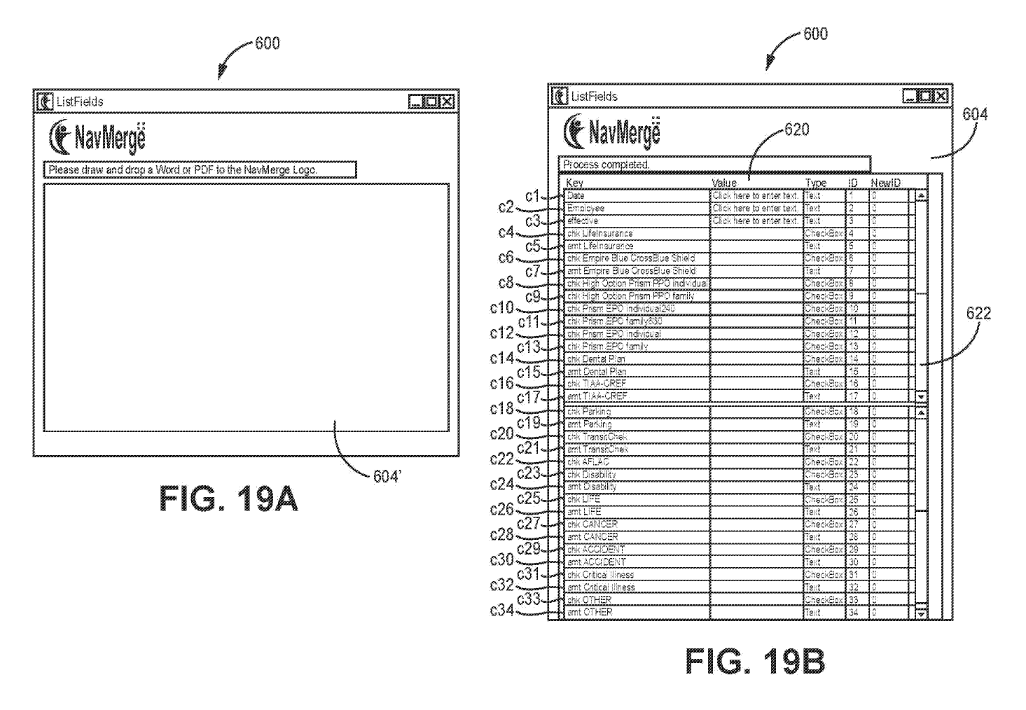

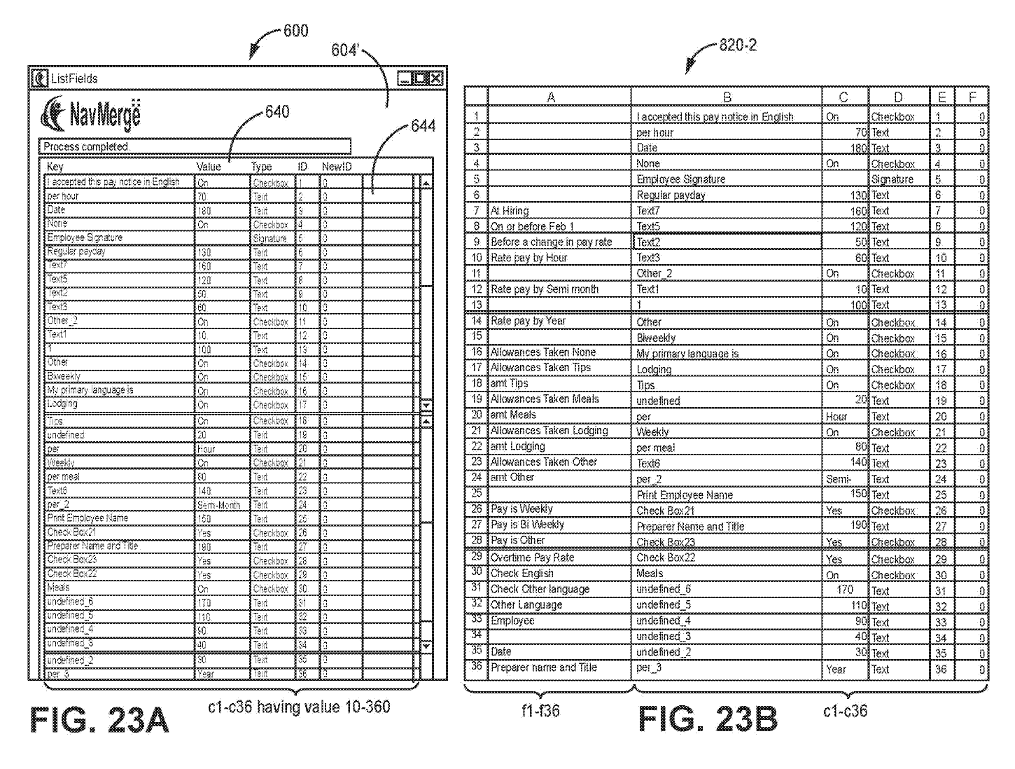

The structure analysis unit 204 of the system is capable of obtaining and extracting custermized parameters such as field identifiers such as f1, f2, f3, . . . fn and content items c1, c2, c3, . . . cn from the input files and make them available in the form of pop-up window, pull-down menu, or tabulate them in the system console for further processing. Referring to panel (b) of FIG. 15, structure analysis window 604 of the system console 600 shows tabulated field identifiers f1-f20 extracted from the input data file of FIG. 3A in the form of a pop up window. The field identifiers f1-f20 are capable of being copied into various fields in the output data interface to provide personalized definition of these fields. For example, referring to panel (a) of FIG. 15, output areas file name 606a and password 606b are defined by the field identifiers f3 and f1, respectively, from the pop up window 604 when Word is chosen as the output format. Referring to panel (c) of FIG. 15, output interface 606′ having an alternative document format PDF chosen is shown, where output areas password 606′a and group password 606′b are defined by the field identifiers f1 and f12 from the pop up window 604 respectively. Referring to panel (d) of FIG. 15, a top portion of an email template 700 is shown having fields F19, F17, F18, and F20 defined by the field identifiers f19, f17, f18, and f20 respectively. An alternative embodiment of structure analysis interface is shown in FIG. 4E. Referring to FIG. 4E, the structure analysis interface 43B is shown in panel (a) listing matching content items from a Word file 43B1 and field identifiers from an Excel input data file 43B2. Panel (b) of FIG. 4E is showing a pull down menu 43B′ listing field identifiers f1 to f19 from the excel input data file of FIG. 3A providing personalized options to 45-E, 42-G, 43-G, and 44-G. Another alternative embodiment of structure analysis interface is shown in FIG. 19. Referring to panel (a) of FIG. 19, the structure analysis interface 604′ is launched in system console 600. When user load a content defined word template into the structure analysis interface 604′, it is populated with content items c1-c34 extracted from the content defined template, shown in panel (b). Alternatively, when a user load a content defined PDF template into the structure analysis interface 604′, it is populated with content items c1-c36 extracted from the content defined PDF template, shown in panel (a) of FIG. 23. Each content items in the PDF is defined with a value in 10 increments, and are listed in the value column 640.

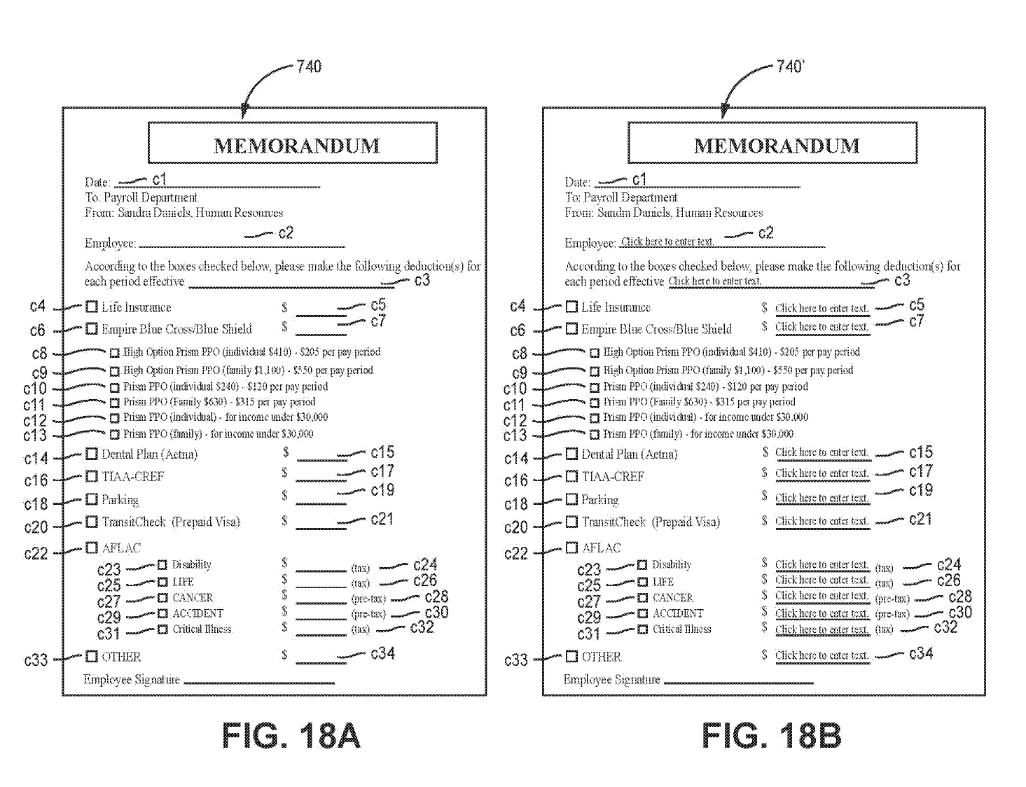

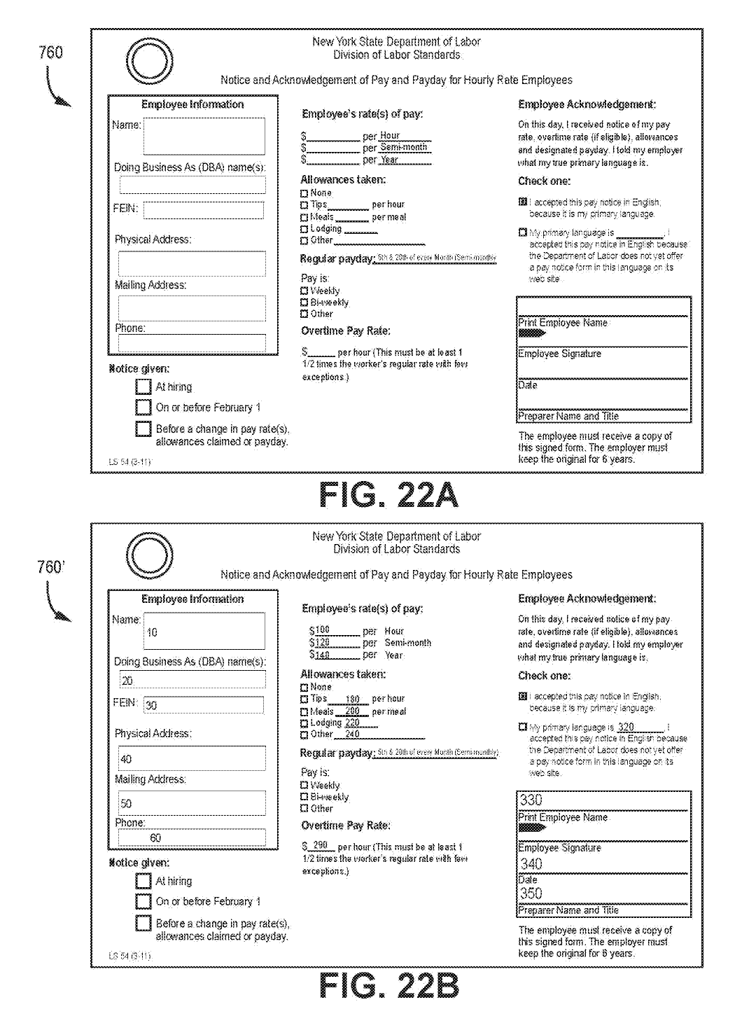

The template file could be raw or mapped file. In one embodiment, the template file is a content defined file having content items c1, c2, c3, . . . cn that corresponds respectively to field identifiers f1, f2, f3, . . . fn of the input data file. In one embodiment the content defined file is defined by Microsoft Content Control. Referring to panel (a) of FIG. 18, an example raw template file 740 prior to content definition is shown having content items c1-c34 to be defined by Microsoft Content Control. Referring to panel (b) of FIG. 18, after content definition, the raw template file 740 is transformed into a content defined template file 740′ having content items c1-c34 defined by content control. In another embodiment, the content defined template file is a PDF file having defined content items. Referring to FIG. 22, a content defined PDF template 760′ having defined content items 10, 20, 30, . . . 360 is shown. In this example, a numeric location label is assigned following a sequence of top to bottom and left to right, i.e. numbers from 10 with increment of 10 are manually inserted into each content item in the first column from top to bottom and then move to the second column and from top to bottom, to assign an unique value to each content item. Each checkbox corresponds to an content item.

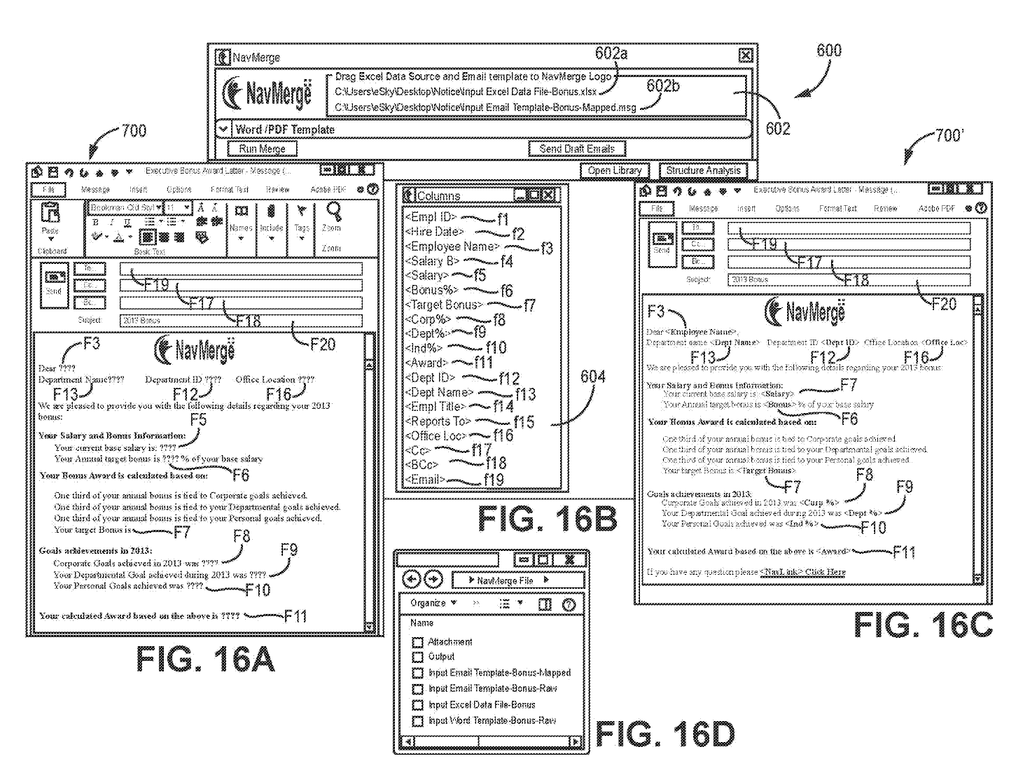

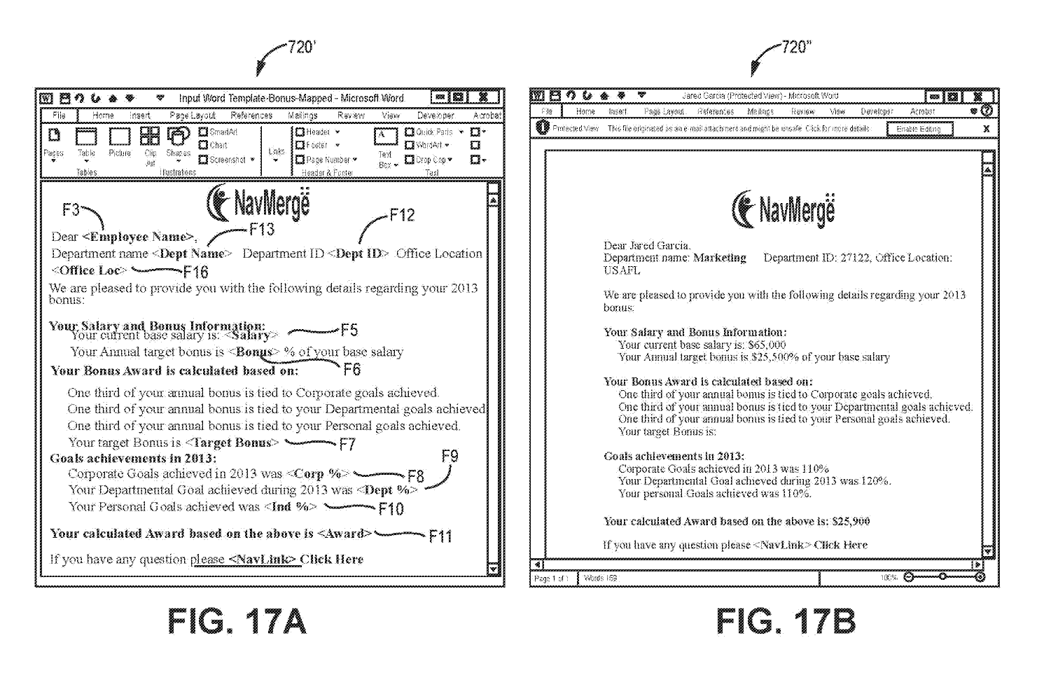

In another embodiment, the template file is a raw template file having fields F1, F2, F3, . . . Fn that corresponds respectively to field identifiers f1, f2, f3, . . . fn of the input data file. In a further embodiment, the template file is a mapped template having fields F1, F2, F3, . . . Fn mapped with respective field identifiers f1, f2, f3, . . . fn of the input data file. Referring to FIG. 16, an example raw email template 700 prior to mapping is shown having fields F1-F15. After mapping, the raw email template file 700 is transformed into a mapped email template file 700′ having fields F3, F5-F13, and F16-F19 mapped with field identifiers f3, f5-f13, and f16-f19 of pop up window 604 respectively. Referring to FIG. 17, an example mapped attachment template 720′ is shown have fields F3, F5-F13, and F16 mapped with field identifiers f3, f5-f13, and f16 respectively.

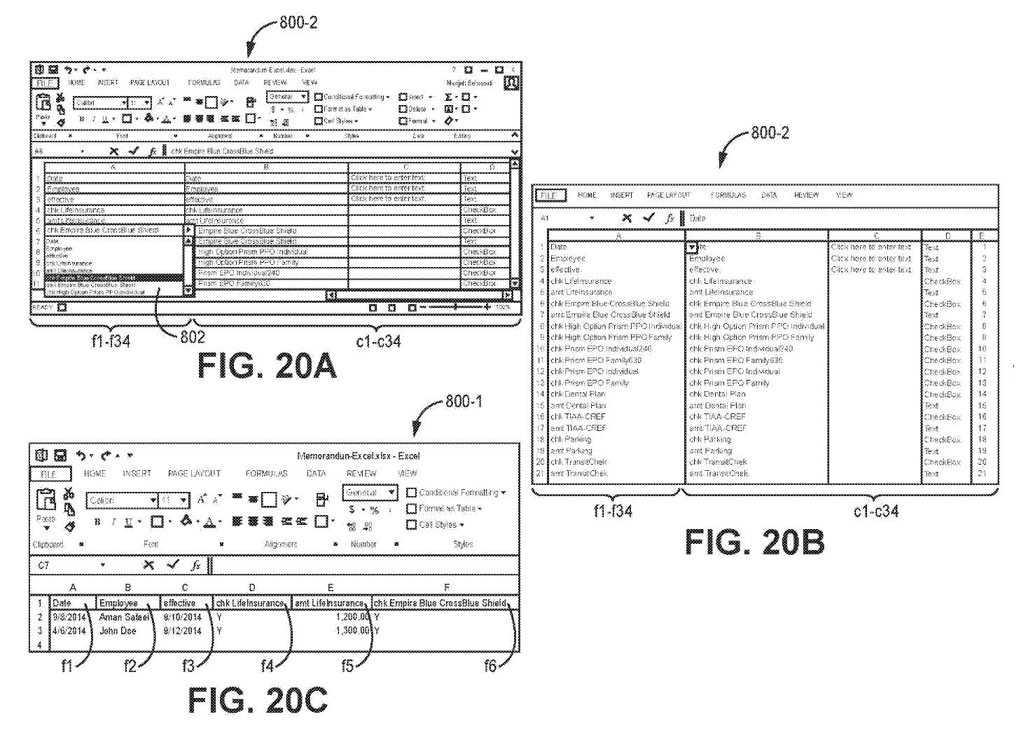

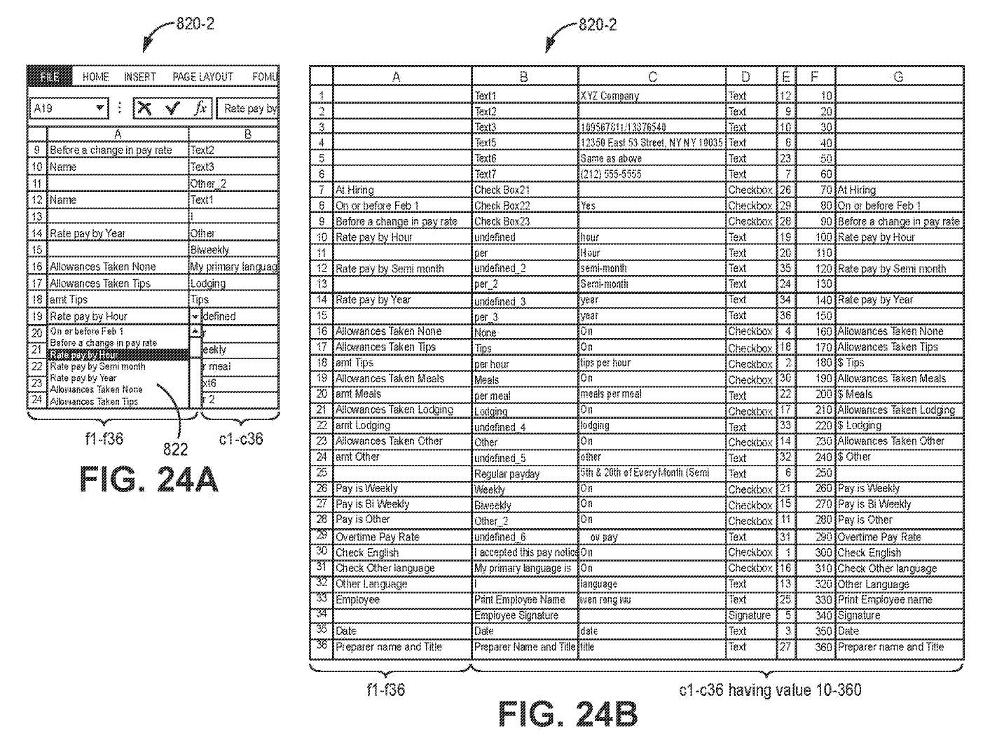

In one embodiment, the template is an input data file matched with content items c1, c2, c3, . . . cn of a content defined template file. One example of matched input data file is shown in FIG. 20. FIG. 20(b) shows in sheet 2 800-2 of the input data file, content items have been matched with corresponding field identifiers. FIG. 20(c) shows input data in sheet 1 800-1 of the input data file. Another example of sheet 2 of matched input data file is shown in FIG. 24. Another example of sheet 1 of matched input data file is shown in FIG> 25.

The output unit 206 provides options for personalizing and storing the created personalized documents. For example, options for the location of a personalized document to be stored; options for personalizing the subject for each generated personalized document, options for the delivery method, such as an attachment or as a link, etc. In some embodiments, when the delivery is in the form of an attachment to an email, the output interface provides additional options, such as the output format of the attachment and password protection, to a user. In one embodiment, the output interface offers an option of having Word as the output format with optional password protection, where the password can be individualized. In one embodiment, the output interface offers an option of having PDF as the output format with optional password protection. The password protection of the PDF option may have two levels of password protection, one individualized password and one with a group password. Referring to FIG. 4E, one embodiment of the output interface commanded at least in part by field identifiers is shown. Referring to FIG. 15, some embodiments of output interface defined at least in part by field identifiers are shown. Referring panel (a) of FIG. 15, output areas 606a file name and 606b password are defined by the field identifiers f3 and f1 from the pop up window 604 respectively when the attachment file is a word file. Referring to panel (c) of FIG. 15, output interface 606′ having an alternative document format PDF chosen is shown, where output areas 606′a password and 606′b group password are defined by the field identifiers f1 and f12 from the pop up window 604 respectively. Referring to panel (d) of FIG. 15, a top portion of an email template 700 is shown having fields F19, F17, F18, and F20 defined by the field identifiers f19, f17, f18, and f20 respectively.

The operation instructions unit 208 provides interface with user to give command to run the system console, such as populating mapped template to create the personalized documents, sending personalized electronic notifications, or perform structure analysis of the files loaded into the input interface. Referring to panel (a) of FIG. 15, an operation instructions interface 608 is shown to have command buttons 608a, 608b, and 608c. Referring to FIG. 4B, an operation instructions interface 40OIU is shown to have button 40OIUa.

In one embodiment, the system disclosed herein may resides in the cloud. Upon authentication, the software is downloaded and resides in the memory of user computer. When the computer is turned off, there is no software on the hard drive. The system may use a technology called click once from Microsoft to enable the system to run entirely in local memory with no communication with the cloud. After the user computer is turned off, when turning the system console back on the user computer, the process above should be repeated. The server checks if an authorized account which is not expired. At the same time, if new version or release of the system is available it gets downloaded automatically. No additional IT support is needed.

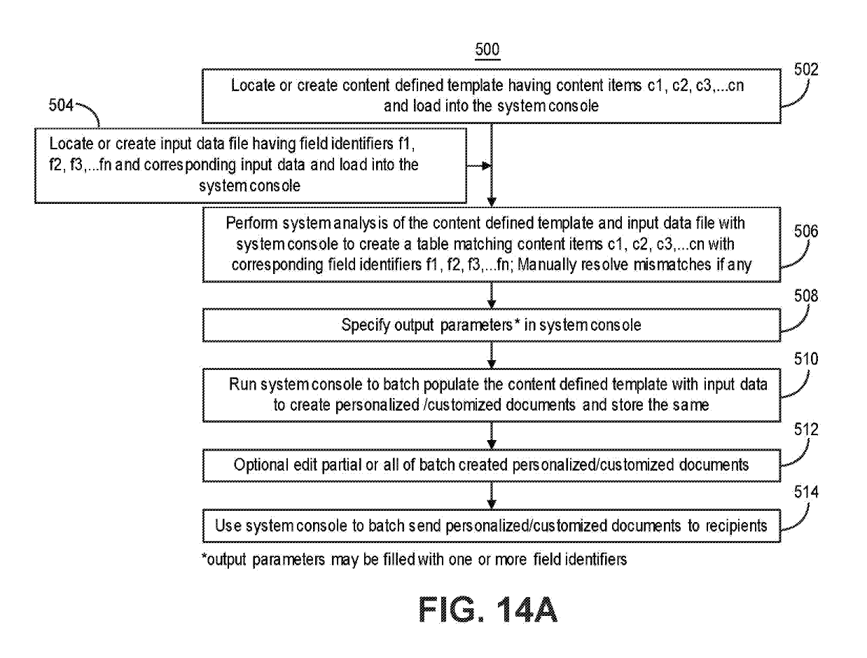

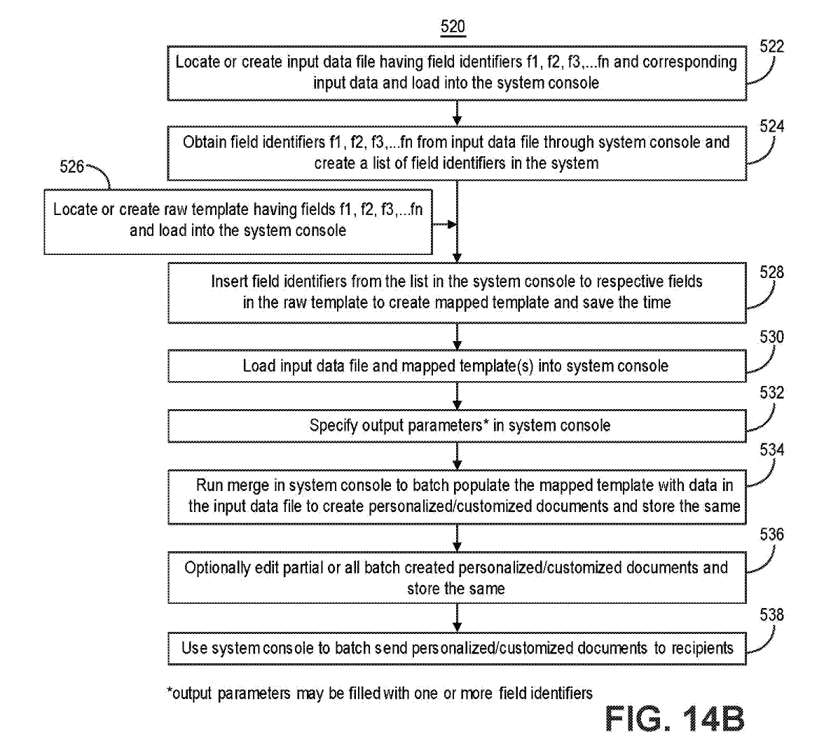

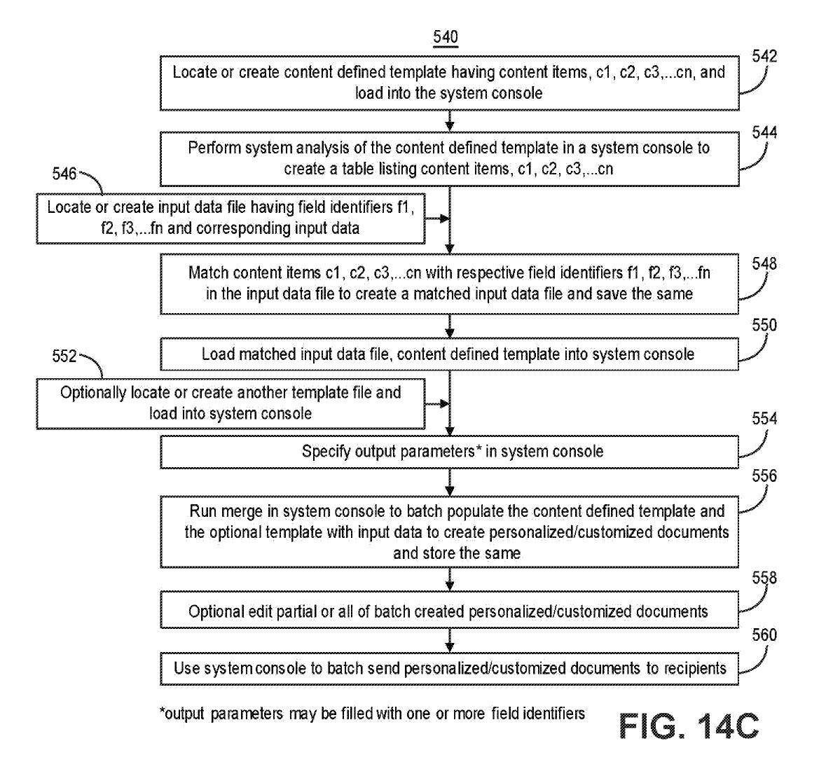

Referring to FIG. 14A-14C, processes 500, 520, and 540 implemented by the system 200 of FIG. 13 is shown. The processes 500, 520, and 540 may be embodied in software in a computing device such as the device 300 or 400 of FIG. 11A and FIG. 11B respectively. Accordingly the processes 500, 520, and 540 may be implemented as computer-executable instructions that, when executed on a processing system such as process unit 302 or 402, perform the operations and tasks illustrated as blocks in FIG. 14A-FIG. 14C.

Referring to FIG. 14A, flowchart 500 illustrates a process for handling batch generate customized documents. At block 502, user locate or create content defined template having content items c1, c2, c3, . . . cn and load into the system console. At block 504, user locate and create input data file having filed identifiers f1, f2, f3, . . . fn and corresponding input data and load into the system console. Upon completing blocks 502 and 504, at block 506, system console performs structural analysis of the content defined template and input data file to create a table, matching content items c1, c2, c3, . . . cn with corresponding field identifiers f1, f2, f3, . . . fn. Any mismatched items are resolved manually to ensure all items in the table is matched. At block 508, user defines output parameters such as file name, format such as word of PDF, having attachment or not. User may fill the output parameters with one or more field identifiers to provide personalized information for each generated document. At block 510, system 200 performs a batch processing to populate the content defined template with input data to create personalized/customized documents and store the same. At block 512, after creating the customized documents, the system allows the user to further edit the created customized documents. At block 514, system sends customized documents to recipients in a batch mode. An example of process 500 is illustrated in FIG. 2A-FIG. 10 discussed in detail above.

Referring to FIG. 14B, process 520 illustrating another embodiment to batch generate customized documents is shown. At block 522, input data file having field identifiers f1, f2, f3, . . . fn and corresponding input data is located or created and load into the system console. An example excel spread sheet as an input data file is shown in FIG. 3A having field identifiers f1-f19 and corresponding input data listed under each field identifier.

At block 524, field identifiers f1, f2, f3, . . . fn are obtained or extracted from input data file through system and a list of field identifiers is created in the system console. Referring to panel (b) of FIG. 15, pop up window 604 of the system console 600 is shown having field identifiers f1-f20 extracted from the input data file of FIG. 3A. The field identifiers f1-f20 are capable of being copied into various fields in the output data interface 606 to provide personalized definition of these fields.

At block 526, a raw template having fields F1, F2, F3, . . . Fn is located or created and loaded into the system. The raw template can be created with user local programs such as Word or Outlook. Referring to FIG. 16, an example raw email template 700 prior to mapping is shown having fields F1-F15. The email template 700 is created in Outlook and symbol “????” is used to mark each field in the body of the email template.

At block 528, field identifiers from the list in the system console is filled into respective fields in the raw template to create mapped template and the mapped template is saved. As shown in FIG. 16, after mapping, the raw email template file 700 is transformed into a mapped email template file 700′ having fields F3, F5-F13, and F16-F19 mapped with field identifiers f3, f5-f13, and f16-f19 of pop up window 604 respectively. Referring to FIG. 17, an example mapped attachment template 720′ is shown have fields F3, F5-F13, and F16 mapped with field identifiers f3, f5-f13, and f16 respectively.

At block 530, input data file and mapped template(s) are loaded into system. Referring to FIG. 16, an example of block 530 is shown having input Excel Data file 602a and Mapped email template 602b loaded into the input interface 602 of system console 600.

At block 532, user defines output parameters such as password protection, naming of attachments, preference in Word or PDF, naming of output files and its location, delivery method as an attachment or a link on a website. The output parameters may be filled with one or more field identifiers to command personalized information for each generated document. An example output parameter is illustrated in panels (a), (b), and (c) of FIG. 15. Personalized password protection of the attachment files can be conducted at this stage. Specifically, password for the Word attachment may be defined by selecting a field identifier e.g. Empl ID from pop up window 604 and dragging and dropping it into password field 606b. Similarly, the subject of the generated email and the name of the generated attachments can also be personalized. As shown in FIG. 15, the subject of the email template F20 is defined with field identifier Dept-name f20 and the name of the attachment 606a is defined as Employee name f3.

At block 534, system 200 is run to batch populate the mapped template with input data to create personalized /customized documents and the personalized /customized documents is stored, for example in a user local program. In some embodiments, the emails generated with or without attachment are stored in a subfolder in the Inbox of MS Outlook. As an example, email template 700 of FIG. 16, after being mapped and populated, will create personalized emails. Referring to panel (b) of FIG. 17, an example populated word attachment 720′ is shown have fields F3, F5-F13, and F16 populated with personal information of Jared Garcia. Email template 700′ of FIG. 15 being populated with personalized information for Albert Hopkins, adding Albert's supervisor Daniel Lawrence to receive a cced copy of the email while the human Resources gets a Bcced copy for archive purposes. After the run in FIG. 15 is performed, all email attachments that are generated will have Empl ID as its password. Alternatively, if PDF is selected as attachment format, system console 600 provides two password options 606′a and 606′b, which can be filled by dragging and dropping Empl ID and Dept ID respectively.

At block 536, option to edit partial or all of batch created customized documents is performed. For example, because the emails are generated with specific subject line, the emails can be sorted based on the subject, for example based on departments as shown in FIG. 15. Emails for a specific department can be cut out of draft folder before the rest of the emails are sent out. Because the personalized subject for the attachment files, the attachment files can be similarly sorted. For example HR can send attachments from a given department to its manager for further review.

At block 538, system sends customized documents to recipients in batch.

Referring to FIG. 14C, process 540 illustrating another embodiment to batch generate customized documents is shown. The process 540 can be used to manage very complex forms in Word and PDF with check boxes such as Form LS-54 mandated by NY labor department.

At block 542, content defined template having content items c1, c2, c3, . . . cn is located or created and load into the system. The content defined template can be a word or a PDF file with checkboxes. For example, referring to panel (b) of FIG. 18, a content defined word template 740′ having content items c1-c34 defined by content control is shown. As shown in FIG. 18, each checkbox is considered a separate content item with a unique c identifier. In another embodiment, the content defined template file is a PDF file having defined content items. Referring to FIG. 22, a content defined PDF template 760′ having defined content items c1-c36 defined by value 10, 20, 30, . . . 360 is shown.

At block 544, a structure analysis is perform on the content defined template in a system to tabulate content items c1, c2, c3, . . . cn. An example content items of the content defined Word template 740′ of FIG. 18 is tabulated and shown in FIG. 19. Although the value column 620 is included in the table, it should be ignored as value is not entered in the Word template. An example content items of the content defined PDF template 760′ of FIG. 22 is tabulated and shown in FIG. 23. Because each content item in template 760′ is assigned a value, value column 640 is shown to have values corresponding to each respective content items of the table.

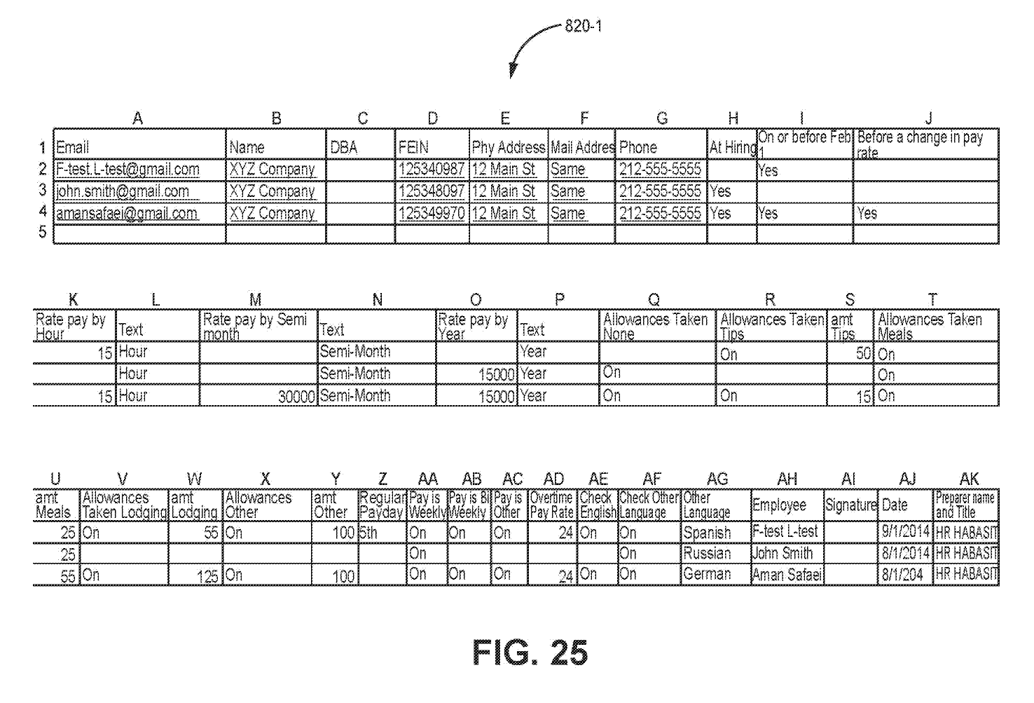

At block 546, input data file having field identifiers f1, f2, f3, . . . fn and corresponding input data is located or created and load into the system console. Referring to FIG. 25, sheet 1 of an input data file 820 is shown as 820-1 having field identifiers and corresponding input data listed under each field identifier. For checkbox items f2 and f3 for example, Y signifies a checked box and blank signifies an unchecked box. Referring to panel (c) of FIG. 20, sheet 1 of an input data file 800 is shown as 800-1 is shown having field identifiers and corresponding input data listed under each field identifier. Again, Y signifies a checked box and blank signifies an unchecked box in the input data.

At block 548, content items c1, c2, c3, . . . cn from the content defined template is matched with respective field identifiers f1, f2, f3, . . . fn in the input data file to create a matched input data file and the matched input data file is saved. An example of the matching process of block 548 is shown in FIG. 20. Specifically, the content items of table 622 is copied and pasted to sheet 2 of the input data sheet 800 starting in column B, where the field identifiers of the input data file 800 is listed in column A. A portion of sheet 2 800-2 is shown in panel (a) of FIG. 23, where each content item in column B is matched with its corresponding field identifier in column A from a pull down menu 802. A fully matched sheet 2 is shown in panel (b) of FIG. 20 with each content item matched with its own field identifier. The input data file with data contained in sheet 1 and matched sheet 2 are saved as a matched input data file.

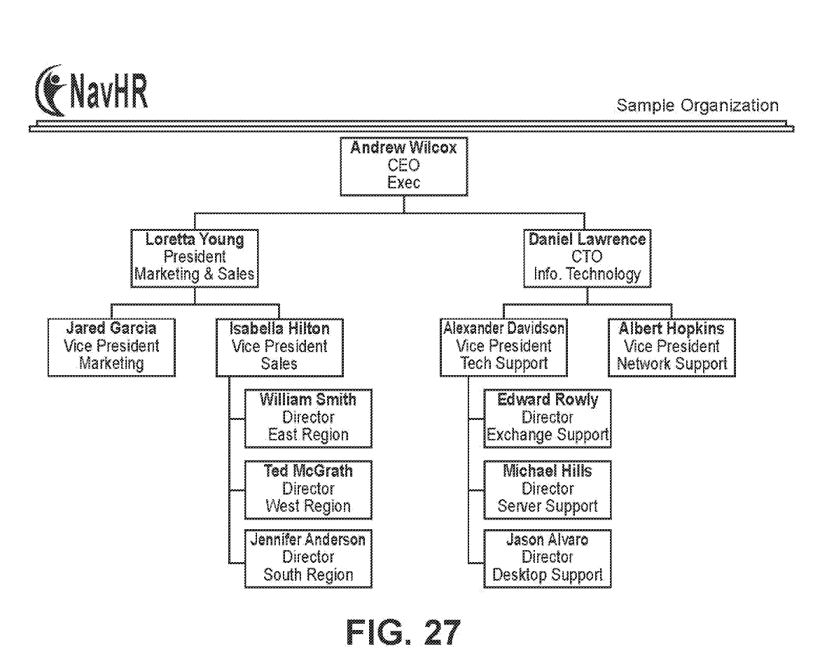

Another example of the matching process of block 548 is shown in 23-FIG. 25. Specifically, the content items of table 642 is copied and pasted to sheet 2 of the input data sheet 820 starting in column B, where the field identifiers of the input data file 800 is listed in column A, to give sheet 2 as 820-2. A portion of sheet 2 820-2 is shown in panel (a) of FIG. 27, where each content item in column B is matched with its corresponding field identifier in column A from a pull down menu 822. A portion of a fully matched sheet 2 is shown in panel (b) of FIG. 24 with each content item matched with its own field identifier. The input data file with data contained in sheet 1 and matched sheet 2 are saved as a matched input data file.

At blocks 550 and 552, the matched input data file and content defined template and an optional another template are loaded into the system. The loading can be accomplished by for example simple dragging and dropping of these files to system console. For content defined Word document discussed above for example, the matched input data file 800, an email template, and the content defined template 740′ are loaded into system console. For content defined PDF document discussed above for example, the matched input data file 820, an email template, and the content defined template 760′ are loaded into system console

At block 554, output parameters such as password protection, naming of attachments, and delivery method as an attachment or a link on a website are defined. The output parameters may be filled with one or more field identifiers to provide personalized information for each generated document. An example output parameter is illustrated in panels (a), (b), and (c) of FIG. 15. Personalized password protection of the attachment files can be conducted at this stage. Similarly, the subject of the generated email and the name of the generated attachments can also be personalized.

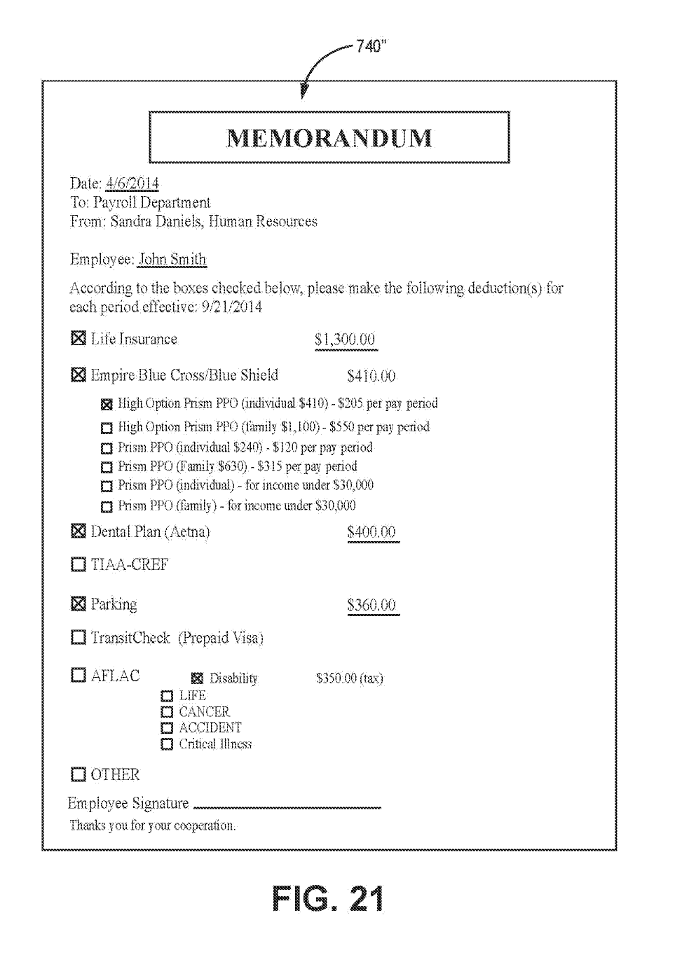

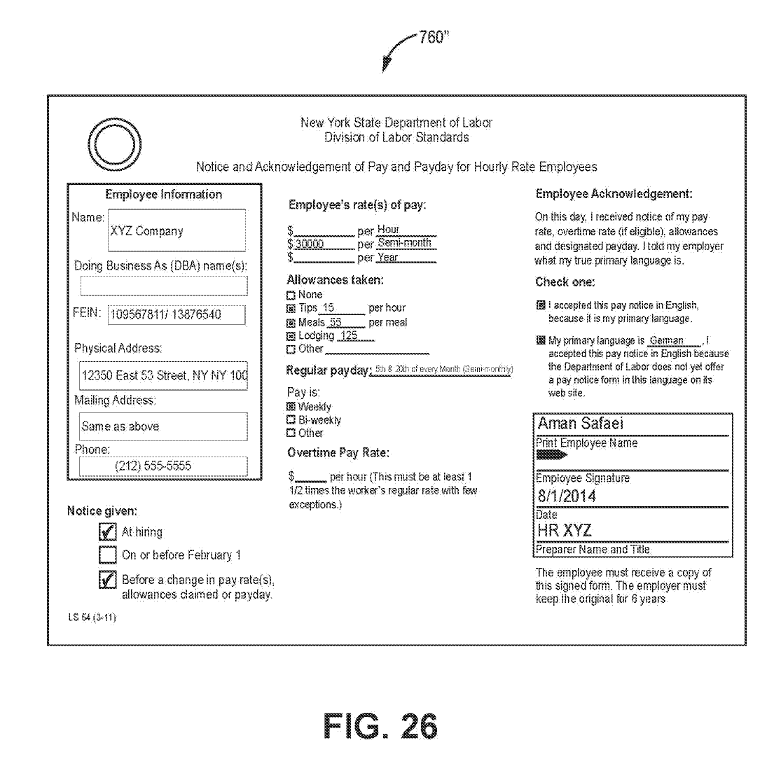

At block 556, system 200 is run to batch populate the content defined template with input data to create customized documents and the personalized/customized documents is stored, for example in a user local program. The optional template is simultaneously populated and stored. When the optional template is an email, for example, personalized email is generated with personalized attachment and stored for example in a subfolder in the Inbox of MS Outlook. Referring to FIG. 21, an example populated word attachment 740″ is shown have content items c1-c34 populated with personal information of John Smith. Referring to FIG. 26, an example populated PDF attachment 760″ is shown have content items c1-c36 populated with customized information of XYZ company.

At block 558, option to edit partial or all of batch created customized documents is performed. For example, because the emails are generated with specific subject line, the emails can be sorted based on the subject, for example based on departments as shown in FIG. 15. Emails for a specific department can be cut out of draft folder before the rest of the emails are sent out. Because the personalized subject for the attachment files, the attachment files can be similarly sorted. For example HR can send attachments from a given department to its manager for further review.

At block 560, system sends customized documents to recipients in batch.

Processes 500, 520, and 540 can be used to send electronic notifications to the recipients with customized information (a) incorporated in the body of Email; (b) attached to the email as Microsoft Word Document with or without password, (c) attached to the email as Adobe PDF Document with or without password or (d) provided as a link to a web site on premise or in the cloud in an Email. The system can be in cloud or on premises. For population of special forms with sensitive data such as Social Security number and salary information, the system can be run on premise without any connection to the Internet. The system can be configured to uses organization's own email system to send email notifications out. Because the electronic notification is stored before sending out, the electronic notifications can be validated and audited before they are sent.

The system may be hosted on the cloud. The system codes (executable and scripts) are digitally signed to make sure the original code compiled are not altered or corrupted since it was signed by cryptographic hash. Every time the user computer is restarted, the system console requires authentication so unauthorized individuals with access to the computer, will not be able to run it.

### EXAMPLES

### Example 1

### How to Create Input Files

PURPOSE OF INPUT FILES: Many organizations are now realizing the need to send personalized communication to their recipients. However, depending on what personalized information they want to communicate with the recipients, they should have them in a file. This may be in an Excel file or comes from a database.

Furthermore, they need to decide on the content and format of the document being generated and sent to recipients. Therefore, they need another input data file. Let's call it Email Template.

When generating output documents, we may have many variations depending on what would be required. As an example, the organization may want to send all the information in an email with a subject matter or they may decide to have part of the communication in the body of email and other parts as an attachment to the email. The attachment may be in Word document. Attachments may or may not be password protected. In those cases that they want some information to be sent as an attachment, they need to provide the format and content of the Word document which will be sent as an attachment. Let's call that “Word Template”.

As a result of the above, we may have the following input files:

WHY DO WE NEED INPUT EXCEL DATA FILE? This file contains the necessary data required for population of templates. Usually created using Microsoft Excel and saved in .xlsx format.

WHY DO WE NEED INPUT EMAIL TEMPLATE? The body of this email contains the information to be sent to recipients. In some cases, the email body should contain what is needed to be communicated to the recipients and therefore, no attachment in Word or PDF is required. In other cases, an attachment might be necessary, and finally this template is usually created in Microsoft Outlook, saved in .msg format.

WHY DO WE NEED INPUT WORD TEMPLATE: Usually required when you want to send attachments to the recipients. Created in Microsoft Word and saved in .docx format

WHY DO WE NEED INPUT PDF TEMPLATE: Usually required when you organizations such as IRS, Labor Departments, etc. . . mandate the use of their form which is in PDF. In these cases, your organization should populate the PDF forms as an attachment to an Email.

In the following examples, we are going to use an example of a company that has decided to notify its senior management team about their annual bonus, what were the variables impacting the bonus amount and how it was calculated. We are using a test company shown in FIG. 27.

CREATING INPUT EXCEL DATA FILE: Creating an excel file is a very simple task. The important step in doing this would be the inclusion of data items required to be communicated to the recipient. You also need to make sure that data item columns on the spreadsheet have a header name. Please note that you might have more information in your Excel file than you need in your template. This is not an issue for NavMerge and there is no need to have the columns in any specific order.

The Excel worksheet example shown in FIG. 3A has the following columns: Employee ID, Hire Date, Employee Name, Salary B that has no $ sign, Salary with $ sign, Bonus % of Salary, Target Bonus calculated by multiplying Salary by Bonus %, Corporate goals achievement %, Departmental goal achievement %, Individual goal achievement %, Award bonus amount calculated based on goals achieved, department ID, department name, Employee Title, Reports to (employee's immediate manager), Office location, CC which contains the email of the person or organization that Email to Recipient should also be copied to, BCC is usually used for archiving purposes, Email is the Email of the recipient of the email. When done, save it as; “Input Excel Data File-Bonus”.

CREATING INPUT EMAIL TEMPLATE: Open Microsoft Outlook and click on “New E-Mail”.

Inserting text in the Email Template message body: The intention of preparing Email body content is to provide as much information as you want to share with bonus recipients about their bonus detail as shown in FIG. 16(a).

You may put “????” or any other character that you want for those data items that should be filled in by NavMerge when processing each person's bonus. This is simply for you to remember that you need to complete the mapping process before running NavMerge program. You may leave it blank or use????????? Or any number of? Instead of (4)????.

Inserting a link Place holder in the Email Template message body: Furthermore, you may be required to place a link within the body of Email allowing recipients to click on to get addition information, attend into promotions or submit their comments and questions. To do this, type in the text you want and add a “Click here”. We will cover the details in Example 2—NavMerge Operation.

You have now completed the Email template and you can save it. Call it “Input Email Template-Bonus-Raw” (Preferred) or any name you want and save it in the “NavMerge Files” folder on the desktop (preferred). If you just click on save, the Microsoft Outlook will automatically save it in the Draft folder of Outlook with no name, then you need to drag it to the “NavMerge Files” folder manually and name it. The reason we want to use Raw at the end of the name is that by looking at the name of template, we realize we haven't yet done the mapping of Input data to this template. We will do that in Section V-NavMerge Operation.

### Creating Input Word Template:

Creating Word Template and sending it as an attachment to the Email: With all the rich features of NavMerge using Input Email Template, it is very unlikely for organization to have the need to use Word Templates as attachments. However, in special cases where sending attachments to the recipient are required, you may use this feature. Attachments may be required when: When you want to password protect the attachments; When you want to send Populated Forms to Recipients in WORD or PDF; When you don't want private info to appear in the body of Emails

All the steps for creating Word Templates would be identical with what we have shown for Email Template and will not be covered here. When using Word Template and creating links to Excel data, you may use two methods:

Method 1: Drag and drop form Spreadsheet into Word Template, recommended by NavMerge and covered in Section V—NavMerge Operation.

Method 2: Using Microsoft Content Control—Only recommended for advanced users since it is more time consuming but it works if you decide to use it.

### Example 2

### NavMerge Operation—General

Using NavMerge Console, you can start operating the system very easily. You need to work on data files and templates that are copied to your own folder on the desktop. You might have changed these data files and templates to accommodate your application. The Operation of Console is based on Drag and Drop Concept. NavMerge Operation includes the following simple and quick steps:

Step 1: Mapping Data Files to Templates

This is required so that NavMerge knows where the input data comes from and where does it go.

Step 2: Placing Logo in the Email Template

In this step we show you how to place a logo or image in the Email Template or Word Template.

Step 3: Creating a Link in the Email Template

This is necessary when you want the recipients to click to a link (inside Email Template or Word Template) and go a web site or URL to see more information or do something you expect them to do.

Step 4: Saving Email Template

Save your work so mapping you have done is saved.

Step 5: Drag and Drop Input Files to Navmerge Logo

Select input files, drag and drop them to NavMerge Logo to get started

Step 6: Using Navmerge Console for Additional Configuration

Depending on what kind of Email you are generating (with or without attachment), you may or may not have configuration selection to make.

Step 7: Running Navmerge

This step populates the Templates with data and creates Emails with or without attachments.

Step 8: Sending Draft Emails

This is necessary to make sure recipients receive the generated Emails and attachments (if any). We will go through the above steps in two ways: With no attachment and with attachment. When there is no attachment, it means all the content will be incorporated in the body of Email. If there is an attachment, the user may decide to simplify the Email body and leave all the details in the attachment.

### Example 3

### NavMerge Operation—No Attachment

Step 1: Mapping Data Files to Templates

Identify your “Input Excel Data File-Bonus” in the “NavMerge Files” folder on the desktop and drag it to NavMerge Logo in the top left corner of the Console. While you are doing this, the logo starts shaking with a message “Drop Files and Wait for Processing”. Release the mouse to drop and you will get a pop up window 604 like FIG. 16(b).

This pop up window contains all the data items in the “Input Excel Data File-Bonus” as default. You will need them in the process of mapping the template.

Now you should open the “Input Email Template-Bonus-Raw” 700 and put it next to this pop up window as shown in FIG. 16:

Starting from top, we need to map the “To” in the Input Email Template-bonus-Raw. To do this, you have two ways: First, select the <Email> in the pop up yellow window by left clicking on it, then move the cursor to the text box on the right side of To . . . and then paste. This will place <Email> in that area. This further signals NavMerge that when running, it has to get the <Email> from “Input Excel Data File-Bonus” and populate the “Input Email Template-Bonus” relevant data item, in this case Email. Continue doing the same for Cc and BCc and you will get something like the screen in FIG. 16(c).

The Subject has already been populated but if you need to change or modify, you can do it. Next field to be mapped is the Logo which requires a special treatment and we will go through it in Step 2 below. The next field to be mapped is the ???? after “Dear” in the template shown above. Again left click on <Employee Name> in the yellow pop up screen, then either select the all the ????, then click on Ctrl-V or paste, or drag and drop <Employee Name> after “Dear” but make sure you delete all ???? after it. Also note that you should leave only one space between “Dear” and <Employee Name> and no space between the <Employee Name> and the comma after it. Follow the same process throughout the template until you are done with the last data item which is <Award>.

Step 2: Saving Email Template

Now that the “Input Email Template-Bonus-Raw” is completed and has the logo, text body, mapped to data elements, and has a link to desired website, you should do a Save AS in the same place where all the NavMerge files reside that is “NavMerge Files” folder on the desktop with a new name of “Input Email Template-Bonus-Mapped”. Now “NavMerge Files” folder looks like FIG. 16(d).

Step 3: Drag and Drop Input Files to Navmerge Logo

Since we are not using any attachment in this scenario, we don't need to use “Input Word Template-Bonus-Raw”. We also have no need for “Input Email Template-Bonus-Raw” since we have created the mapped version. Now you should select only two files; “Input Excel Data File-Bonus” and “Input Email Template-Bonus-Mapped” and drag them to NavMerge Logo and release the mouse so you drop them there. After doing so, you will see a screen of FIG. 16(b).

The two files we dropped are now displayed to the right of the Logo. Logo is also back to normal. Also please notice that in the “NavMerge Files” folder, NavMerge has created two folders (Attachment and Output) as a default as shown in FIG. 16(d).

Step 4: Using Navmerge Console for Additional Configuration

For this scenario, we have no available configuration to select. If you look at the Console after the above drag and drop, there is nothing there except Run and Send Draft Emails button that we will cover.

Step 5: Running Navmerge

When clicked, NavMerge starts generating the Emails as configured. The final result of the generation process would be numerous Emails that will be stored in the draft folder of NavMerge. As a default, our software system creates a folder called NavMerge under the Inbox of Outlook. Underneath NavMerge, our software system also creates a folder called Draft. All the generated emails are stored in this Draft folder as shown below until such time that the user examines the content, edits them if necessary and then sends them out.

Step 6: Sending Draft Emails

This is the very last steps where NavMerge empties your draft folder in no time. All Emails are sent out to recipients when this button is clicked.

### Example 4

### NavMerge Operation—With Attachment

When you are planning to send personalized attachments, you should have an Email body to be able to attach a Word or PDF document to it. Therefore, in this scenario, you not only need the Input Excel Data File-Bonus, and Input Word Template-Bonus-Mapped but you also need Input Email Template-Bonus-Mapped. As a result, when using personalized attachments, you will have three input files as follow: Input Excel Data File-Bonus; Input Email Template-Bonus-Attach-Raw; Input Word Template-Bonus-Raw.

However, before we drag them to the NavMerge logo, we need to create a mapped version of Email Template and Word Template. We cannot drag the raw versions. After doing those two tasks, we can drag and drop the three files.

Step 1: Mapping Data File to Email Template

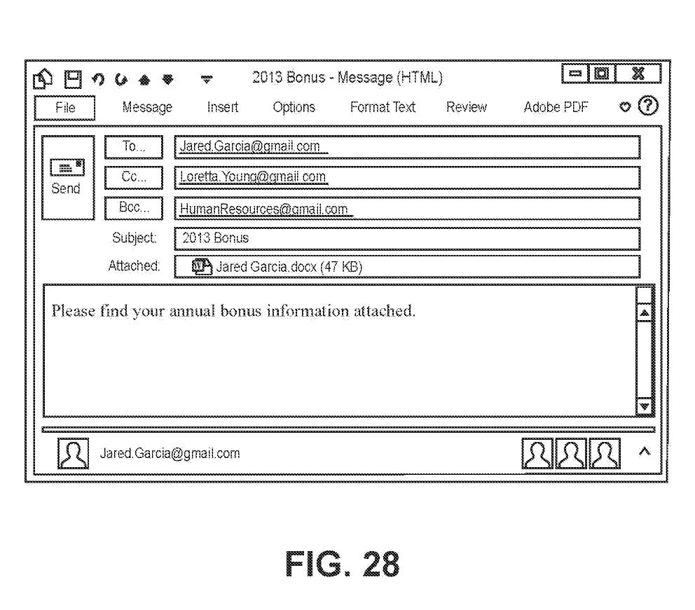

We may have a raw versions which we used before. If not, we can create a new Email and save it as raw version. Now in this email template, we need to create what is required here. Since we are putting all the details of the bonus in the word template as an attachment, it is not really necessary to have a lot of details in the email template. Let's therefore, be very brief in the body of email template shown in FIG. 28(a).

Step 2: Mapping Data File to Word Template

Similar to what we did for mapping the No-attachment version, complete mapping of “Input Excel Data File-Bonus” to “Input Word Template-Bonus-Raw”, after completion it looks like FIG. 17(a).

Step 3: Saving Email Template with New Name: Similar to what was discussed in example 3.

Step 4: Drag and Drop Input Files to Navmerge Logo:

Let's now drag the three input files, (two mapped files and one Excel file) to NavMerge logo. You will get system console of FIG. 15(a).

The first thing noticeable is that NavMerge automatically expands the Console and shows a lot of options underneath Word Template.

Again, to the right of NavMerge logo, we will have the two input files we had before. To the right and underneath Word Template, we will have the name of the Word Template which was mapped.

Step 5: Navmerge Configuration for Attachments: We now need to configure the Output files which are being generated as an attachment. Please note that we have two distinct sections under Word Template, “Output To” Section and “Document” Section. We will go over them one by one:

“Output To” Section: In this section, we are defining the Output folder where the attachments will be stored in. Usually this will be named Output folder. We also tell NavMrege what naming convention should be used for attachments being generated. Usually the preferred practice would be to use Employee Name as the name of the attachment so it is clear and is searchable in case you need to find it. To tell NavMerge about your preference here, click on the Input Excel Data File-Bonus.xlsx and the yellow pop up window 604 of FIG. 15(b) will appear. Left click on the <Employee Name> and then move your cursor to the text filed which is on the right of File Name and paste. <Employee Name> will be inserted there. Next selection will be your preferred delivery. Do you prefer the attachment generated to be attached to the email or do you want to be saved and its link be sent to the recipient? This selection is simply a radio button.

“Document” Section: In this section, we will define the format of the document being generated and options are either Word or PDF. The good thing is that you don't have to worry about the conversion from Word to PDF. NavMerge will do this automatically.

If you select the Word Format, you need to provide the Password. This means your attachment will be password protected. You may leave it blank for no protection of course. If you decide to use a password, you must select the password from the yellow popup list. In this example, Human Resources may inform employees that each individual password will be constructed by the combination of Employee-ID and last four digits of social security #. Remember here that if an employee's manager is copied on the email and receives an attachment, he or she cannot open that attachment since the manager is not supposed to know the password of Employee. In this option, the file is also encrypted which means search engines will not be able to display the contents.

If you select the PDF Format (as shown below), you will notice that in addition to the Password, you will be prompted to provide a Group Password as well as shown in FIG. 15(c). This Group Password is used for managers to access that attachment and for example, Human Resources and managers may decide to use Department-ID as the Group Password for a specific department. Again, you must have this field in the yellow popup window to select it.

Step 6: Run Merge: Clicking on “Run Merge” will generate the emails with attachment with password protection as configured. As we continue generating the green bar moves from left to right indicating the progress.

As you know, all generated Emails are stored in the draft folder under NavMerge folder which is created in the Outlook Inbox. Let's go to draft folder and open one of the emails and it looks like FIG. 28(a).

Click to open the attachment that is in Word and you get a window to enter the password. Look up Employee-ID for Jared in the Input Excel Data File and it is 234569. Enter that in the password area and click OK and it opens the document in Word that looks like FIG. 17(b).

Step 7: Sending Draft Emails: Clicking on Send Draft Emails will send all emails in the draft folder out.

### Example 5

### Advance Features, Auto Fill of Complex Attachments in Word

How to Handle Complex forms with Check Boxes, Plain and Rich text in Word?

One of the advanced features of NavMerge is to populate complex Word documents with check boxes. To do this, NavMerge uses its built-in features and provides customers with an automated process to populate their customized forms. One of the many complex Microsoft forms may look like FIG. 18(a)

For NavMerge to fill out the above form for 50 or 20,000 employees automatically, we need to prep the above Word document for NavMerge to understand and populate it. This process is performed only once and the rest would be automatic.

Microsoft Word has a built in technique called Content Control which we need to use in this example. Content Control allows each variable to be defined within a Word document and its location and name is defined so NavMerge can the relevant data elements in the spreadsheet and populate them properly. We can also use some of the native drag and drop functions of NavMerge to populate the fields but not checkboxes.

After Insertion of Content Controls, the document should be saved. Let's call this doc Word-Template 1. When it is saved it looks like FIG. 18(b).

Now that the form (Microsoft Word document) is completed and all the Content Controls are in place, we need to figure out how the mapping of data elements from spreadsheet to the Content Control variables should be done. This is where the powerful feature of NavMerge Structure Analysis is used to do the job. Simply click on Structure Analysis of NavMerge console and you get FIG. 19(a). Now select the saved Memorandum Word file above with Content controls, drag and drop it to the Logo in the above window. You will get the screen shown in FIG. 19(b).

During the analysis, NavMerge automatically parses the content controls as well as data types (check boxes, text, . . . ) and builds a table that is displayed and has the five columns with the following headings:

Key: this column contains the name or description of field tagged with Content Control.

Value: This column is only for PDF forms and is not applicable here.

Type: This columns shows the type of Content Control such as Check Box, Rich Text, Radio button, etc . . .

ID: This column contains the sequence of data items tagged with Content Control. It starts with 1 and increments by 1. It is called ID.

NewID: Used for PDF forms in case you need to re-order the fields. The sequence of re-order is left to right and top to bottom. Not applicable here.

Mapping:

Now it is logical to somehow tell NavMerge to get input data from Excel and place them in the form using Content Control references. This is called Mapping.

To do the mapping, we either have to go to Excel, consider each data item and find its corresponding data item in the form with Content Control, or go to the form, take one content at a time and find its corresponding data item in the excel. We prefer the later since it is more efficient and effective.

To perform this function, click on the first row in the Structure Analysis window, then hold shift key and page down until all rows are selected. Then copy (Ctrl+V) and then go to excel input data, open it, go to sheet 2, go to cell B1 and paste. Cell A2, A2, . . . is for Excel contents.

Now select first data items in B1 which is Date. Go to A1 and click on the pull down arrow to the right of A1 cell. This will make all data elements in the Excel available for selection as shown in FIG. 20(a). From this pull down, select the appropriate corresponding data element in the Excel. Continue this mapping process with B2 cell, B3 cell, . . . all the way to B34.

The result looks like FIG. 20(b). Please note that our Excel data elements headings in this example are the same as the Content Control Variables in the Memorandum Word document but it is not necessary to be the same.

Now you should save the spreadsheet with changes and the latest mappings you have done.

Running NavMere:

Now drag and drop the following three files to NavMerge Logo:

File 1—Excel original file with Sheet 2 mapped; Memorandum-Excel

File 2—Email template; Memorandum-Email

File 3—Word Document which was saved as Memorandum-Word with Content Controls

Make sure Outlook is running and draft folder under NavMerge is empty. Click Run and watch emails being generated.

Please note that when we have check boxes in the form, we need to tell NavMerge if the check boxes are checked or not checked. Therefore, we need a corresponding column in Excel saying yes for checked as show in FIG. 20(c).

The populated Memorandum looks like FIG. 21.

### Example 6

### Advance Features, Auto Fill of Complex Attachments in PDF

How to handle Government PDF forms that must be filled but cannot be changed?

There are situation under which many corporations are mandated to fill our special government forms which are usually in PDF format. In many of these cases, the forms need to be filled for each employee, each situation, or each contract or each event. The end result would be tremendous manual work required to fill out each form since the forms are must be personalized or customized to each case.

An example of these forms are W-2, W-9 or LS-54 and the like.

Fortunately, NavMerge has a built-in feature which allows any kind of complex PDF document be filled automatically even if they have check boxes in them. For example, a blank the Labor Department PDF form LS-54 is shown in FIG. 21(a).

This form needs to be filled by employers in NY State at least once per year for each employee and whenever there is new hire or when the pay rate changes.

The developer of pdf form can make a big difference here. Depending how organized the designer of form has been, the job might be easier or more difficult.

Usually when designing PDF forms, the designer should follow a sequence of left to right and top to bottom. To understand this, we manually insert numbers from 10 with increment of 10 into each entry field in the first column from top to bottom and then move to the second column and fill from top to bottom, and so on. We also check all the boxes. After completing the form, we should save it. The file looks like FIG. 22(b).

Please note that we cannot number checkboxes on the form but we have to allow a number for each checkbox or text value so we can further map then in Excel.

We now open the structure Analysis and move the above saved file to the logo. We get FIG. 23(a).

Mapping:

Now we should copy all the rows in the Structure Analysis and paste it into the sheet 2 of spreadsheet beginning from cell B2. The result looks like FIG. 23(b).

Now by looking at the numbers in sequence, starting from 10, we should find the corresponding fields in the sheet 2 column A from the pull down menue as shown in FIG. 24(a). Checkboxes are challenging and requires trail and error.

Continue until this is completeley done and all fields are mapped.

The mapped file looks like FIG. 24(b) and is sorted on column F with appropriate sequence.

This is only a one time job that needs to be perfromed for each form. Input data are stored in sheet 1 of the form which is shown in FIG. 25. Now the mapped spreadsheets must be saved.

Running NavMerge:

Now drag and drop three files to NavMerge Logo. They are:

File 1—Excel with Sheet 2 mapped; Notice Of Acknowledgement of Pay Rate Pay day.xlsx

File 2—Email template; Notice Of Acknowledgement of Pay Rate Pay day.msg

File 3—PDF Document as Notice Of Acknowledgement of Pay Rate Pay day.pdf

Make sure Outlook is running and draft folder under NavMerge is empty. Click Run and watch emails being generated.

The populated form by NavMerge is shown in FIG. 26.

The embodiments above are intended to be illustrative and not limiting. Additional embodiments are within the claims. In addition, although the present disclosure has been described with reference to particular embodiments, those skilled in the art will recognize that changes can be made in form and detail without departing from the spirit and scope of the disclosure. Any incorporation by reference of documents above is limited such that no subject matter is incorporated that is contrary to the explicit disclosure herein.

We claim:

1. An apparatus for batch creating a plurality of customized emails, each email contain a primary recipient's individual information, comprising,
an input unit for receiving input files from a storage unit, the input files including an input data file, email templates, and document templates, the input data file having a plurality of field identifiers,
a structure analysis unit for analyzing the input files and extracting customized parameters,
an operation instructions unit interfacting with a user, and
an output unit for creating output files customized according to the customized parameters.

2. The apparatus of claim 1, further comprising user local programs that are operably interfaced with the apparatus.

3. The apparatus of claim 1, wherein the input data file is an excel file, a csv file, or a database file.

4. The apparatus of claim 1, wherein the document template is a mapped template or content defined template.

5. The apparatus of claim 1, wherein the input data file is a matched input data file and the attachment template is a content defined template.

6. A method for creating and sending a plurality of customized emails with optional customized attachments in batch mode, comprising,
receiving, by an input unit, input files from a storage unit, the input files including an input data file, an email template file, and document template files, the input data file having a plurality of field identifiers,
extracting by structure analysis unit, the plurality of field identifiers from the input data file,
creating, by an output unit, in a batch mode, customized emails, and
sending, by the operation instructions unit, in the batch mode, the customized emails to designated recipients.

7. The method of claim 6, further comprising mapping the document template with field identifiers from the input data file.

8. The method of claim 6, further comprising defining content items of the document template.

9. The method of claim 8, wherein each content items in the document template is defined with a location label.

10. The method of claim 8, further comprising extracting, by structure analysis unit content items from document template and tabulate in a system console.

11. The method of claim 10, further comprising matching the field identifiers in the input data file with the content items of the document template to create a matched input data file.

12. The method of claim 6, further comprising defining output parameters with field identifiers.

13. A computer-readable storage medium having computer-executable instructions for implementing the method of claim 6.

14. An apparatus, for creating in a batch mode a plurality of customized electronic notifications, each electronic notification being customized with a primary recipient's individual information, comprising,
an input unit for receiving input files from a storage unit, the input files comprising an input data file having a plurality of field identifiers and at least one template file,
a structure analysis unit for analyzing the input files and extracting customizing parameters,
an operation instructions unit for interfacing with a user, and
an output unit for creating customized documents according to the customized parameters.

15. The apparatus of claim 14, further comprising user local programs that are operably interfaced with the apparatus.

16. The apparatus of claim 14, wherein the input data file is an excel file, a csv file, or a database file.

17. The apparatus of claim 14, wherein the customized document is a word document, a RTF document, a PDF document, a text document, a XML document, a HTML document, an instant messaging document, or an email document.

18. The apparatus of claim 14, wherein the template is a mapped template or content defined template.

19. The apparatus of claim 14, wherein the input data file is a matched input data file and the template is a content defined template.

20. A method running the apparatus of claim 14.
